(19) United States
(12) Patent Application Publication
(10) Pub. No.: US 2025/0174993 A1
(43) Pub. Date: May 29, 2025

(54) ELECTRONIC CONTROLLER AND COMMUNICATION SYSTEM

(71) Applicant: DENSO CORPORATION, Kariya-city (JP)

(72) Inventors: Ryota KAMEOKA, Kariya-city (JP); Tomohisa KISHIGAMI, Kariya-city (JP); Tomoya TOKUNAGA, Kariya-city (JP); Akira TADA, Kariya-city (JP); Yuta KAWAMURA, Kariya-city (JP)

(21) Appl. No.: 18/953,149

(22) Filed: Nov. 20, 2024

(30) Foreign Application Priority Data
Nov. 29, 2023 (JP) 2023-201682
Sep. 6, 2024 (JP) 2024-153933

(51) Int. Cl. H02J 3/14; H02J 9/00

(52) U.S. Cl. CPC H02J 3/14; H02J 9/005

(57) ABSTRACT

An electronic controller receives power from a power source through a power switch. The electronic controller includes an end notification unit and a sleep transition unit. The end notification unit transmits an end notification to a power supply controller when a predetermined disconnection condition is met. The predetermined disconnection condition indicates the power switch connected to the electronic controller is allowed to switch to a disconnected state. The sleep transition unit puts the electronic controller into a sleep mode when the sleep transition unit does not receive the communication frame from any one of communication devices connected to the electronic controller for a predetermined reception determination period after the disconnection condition was met.

### CROSS REFERENCE TO RELATED APPLICATION

The present application claims the benefit of priority from Japanese Patent Application No. 2023-201682 filed on Nov. 29, 2023, and Japanese Patent Application No. 2024-153933 filed on Sep. 6, 2024. The entire disclosure of the above applications is incorporated herein by reference.

### TECHNICAL FIELD

The present disclosure relates to an electronic controller and a communication system.

### BACKGROUND

There is an in-vehicle network system that includes a power relay for selectively switching the power of multiple electronic controllers.

### SUMMARY

One aspect of the present disclosure is an electronic controller configured to receive power from a power source via a power switch. The power switch is controlled, by a power supply controller, to selectively switch between a connected state in which a power supply path is electrically connected to the power source and a disconnected state in which the power supply path is electrically disconnected from the power source.

The electronic controller of the present disclosure includes an end notification unit and a sleep transition unit.

The end notification unit is configured to transmit an end notification to the power supply controller when a predetermined disconnection condition is met. The predetermined disconnection condition indicates that the power switch connected to the electronic controller is allowed to switch to the disconnected state. The power supply controller is configured to exchange a communication frame with the electronic controller.

The sleep transition unit is configured to put the electronic controller into a sleep mode when the sleep transition unit does not receive the communication frame from any one of the communication devices for a predetermined reception determination period after the disconnection condition was met.

Another aspect of the present disclosure is an electronic controller configured to receive power from a power source via at least one of power switches. Each of the power switches is configured to selectively switch between a connected state in which a power supply path is electrically connected to the power source and a disconnected state in which the power supply path is electrically disconnected from the power source.

The electronic controller of the present disclosure includes a disconnection transition unit. The disconnection transition unit is configured to put the electronic controller into a stop mode or a sleep mode when switch state information, which is received from a power supply controller, indicates that all the power switches are in the disconnected state or all the power switches except for the at least one of the power switches connected to the electronic controller are in the disconnected state. The power supply controller is communicatively connected to the electronic controller and configured to control the at least one of the power switches. The switch state information indicates each of the power switches is in the connected state or the disconnected state.

Yet another aspect of the present disclosure is a communication system including a first controller and a second controller. The first controller receives electric power from a power source via a power switch configured to selectively switch between a connected state in which a power supply path is electrically connected to the power source and a disconnected state in which the power supply path is electrically disconnected from the power source. The second controller is communicatively connected to the first controller. The second controller is configured to exchange a communication frame and control the power switch.

The first controller includes an end notification unit and a sleep transition unit.

The end notification unit is configured to transmit an end notification to the second controller when a predetermined disconnection condition is met. The predetermined disconnection condition indicates that the power switch connected to the first controller is allowed to switch to the disconnected state.

The sleep transition unit is configured to put the first controller into the sleep mode when the sleep transition unit does not receive the communication frame from any one of the communication devices for a predetermined reception determination period after the disconnection condition was met.

Yet another aspect of the present disclosure is a communication system including power switches, a first controller, and a second controller. Each of the power switches is configured to selectively switch between a connected state in which a power supply path is electrically connected to a power source and a disconnected state in which the power supply path is electrically disconnected from the power source. The first controller receives electric power from the power source through at least one of the power switches. The second controller is communicatively connected to the first controller for data communication and configured to control the power switches.

The second controller includes a state information transmitting unit. The state information transmitting unit is configured to transmit switch state information to the first controller. The switch state information indicates that each of the power switches is in the connected state or the disconnected state.

The first controller includes a disconnection transition unit. The disconnection transition unit is configured to put the first controller into a stop mode or a sleep mode when the switch state information, which is received from the second controller, indicates all the power switches are in the disconnected state or all the power switches except for the at least one of the power switches connected to the first controller are in the disconnected state.

### BRIEF DESCRIPTION OF THE DRAWINGS

FIG. 1 is a block diagram illustrating the configuration of a communication system according to first and second embodiments.

FIG. 2 is a flowchart showing state transition processing according to the first embodiment.

FIG. 3 is a flowchart showing state transmission processing according to the second embodiment.

FIG. 4 is a flowchart showing state transition processing according to the second embodiment.

FIG. 5 is a block diagram illustrating the configuration of a communication system according to a third embodiment.

FIG. 6 is an explanatory diagram illustrating affiliation information and activation information.

FIG. 7 is a block diagram illustrating the configuration of a communication system according to a fourth embodiment.

FIG. 8 is a diagram illustrating a correspondence between control targets and clusters.

FIG. 9 is a block diagram illustrating the configuration of a communication system according to a fifth embodiment.

FIG. 10 is a block diagram showing the configuration of a central ECU and upstream power distribution units according to the fifth embodiment.

FIG. 11 is a first block diagram illustrating the configuration of zone ECUs according to the fifth embodiment.

FIG. 12 is a second block diagram illustrating the configuration of the zone ECUs according to the fifth embodiment.

FIG. 13 is a block diagram illustrating the configuration of slave ECUs according to the fifth embodiment.

FIG. 14 is a diagram illustrating the configuration of an activation table according to the fifth embodiment.

FIG. 15 is a flowchart showing state transition processing according to the fifth embodiment.

FIG. 16 is a diagram showing the configuration of activation tables according to the sixth embodiment.

FIG. 17 is a first block diagram illustrating the configuration of zone ECUs according to the sixth embodiment.

FIG. 18 is a second block diagram illustrating the configuration of the zone ECUs according to the sixth embodiment.

FIG. 19 is a flowchart showing state transition processing according to the sixth embodiment.

FIG. 20 is a flowchart showing state transmission processing according to the seventh embodiment.

FIG. 21 is a flowchart showing state transition processing according to the seventh embodiment.

### DETAILED DESCRIPTION OF THE PREFERRED EMBODIMENTS

To begin with, examples of relevant techniques will be described.

There is an in-vehicle network system that includes a power relay for selectively switching the power of multiple electronic controllers. The in-vehicle network system determines control contents for switching of the power of a specified electronic controller based on a scene selected based on a vehicle situation. The in-vehicle network system uses the power relay to switch the power of the specified electronic controller based on the determined control contents.

Detailed studies by the inventors found a case in which power is consumed wastefully in a communication system that includes multiple control devices and that is configured to switch on/off of the control devices.

It is an objective of the present disclosure to reduce power consumption in a communication system.

One aspect of the present disclosure is an electronic controller configured to receive power from a power source via a power switch. The power switch is controlled, by a power supply controller, to selectively switch between a connected state in which a power supply path is electrically connected to the power source and a disconnected state in which the power supply path is electrically disconnected from the power source.

The electronic controller of the present disclosure includes an end notification unit and a sleep transition unit.

The end notification unit is configured to transmit an end notification to the power supply controller when a predetermined disconnection condition is met. The predetermined disconnection condition indicates that the power switch connected to the electronic controller is allowed to switch to the disconnected state. The power supply controller is configured to exchange a communication frame with the electronic controller.

The sleep transition unit is configured to put the electronic controller into a sleep mode when the sleep transition unit does not receive the communication frame from any one of the communication devices for a predetermined reception determination period after the disconnection condition was met.

The electronic controller of the present disclosure configured in this manner can enter the sleep mode even if a malfunction occurs in which the power supply controller having received an end notification from the electronic controller fails to switch the power switch to the disconnected state. For this reason, the electronic controller of the present disclosure can avoid staying in the wake-up with the power switch in the connected state even though the electronic controller is allowed to stop operating by setting the power switch to the disconnected state. Thus, the electronic controller can avoid wasting electric power and the communication system can reduce power consumption.

Another aspect of the present disclosure is an electronic controller configured to receive power from a power source via at least one of power switches. Each of the power switches is configured to selectively switch between a connected state in which a power supply path is electrically connected to the power source and a disconnected state in which the power supply path is electrically disconnected from the power source.

The electronic controller of the present disclosure includes a disconnection transition unit. The disconnection transition unit is configured to put the electronic controller into a stop mode or a sleep mode when switch state information, which is received from a power supply controller, indicates that all the power switches are in the disconnected state or all the power switches except for the at least one of the power switches connected to the electronic controller are in the disconnected state. The power supply controller is communicatively connected to the electronic controller and configured to control the at least one of the power switches. The switch state information indicates each of the power switches is in the connected state or the disconnected state.

The electronic controller of the present disclosure configured in this manner can prevent abnormal situations in which the electronic controller keeps operating with all the power switches in the disconnected state or with all the power switches except the power switch connected to the subject electronic controller in the disconnected state. Thus, the electronic controller can avoid wasting electric power and reduce power consumption in the communication system.

Yet another aspect of the present disclosure is a communication system including a first controller and a second controller. The first controller receives electric power from a power source via a power switch configured to selectively switch between a connected state in which a power supply path is electrically connected to the power source and a disconnected state in which the power supply path is electrically disconnected from the power source. The second controller is communicatively connected to the first controller. The second controller is configured to exchange a communication frame and control the power switch.

The first controller includes an end notification unit and a sleep transition unit.

The end notification unit is configured to transmit an end notification to the second controller when a predetermined disconnection condition is met. The predetermined disconnection condition indicates that the power switch connected to the first controller is allowed to switch to the disconnected state.

The sleep transition unit is configured to put the first controller into the sleep mode when the sleep transition unit does not receive the communication frame from any one of the communication devices for a predetermined reception determination period after the disconnection condition was met.

The communication system of the present disclosure configured in this manner can put the first controller into the sleep mode even if a malfunction occurs in which the second controller having received an end notification from the first controller fails to switch the power switch to the disconnected state. For this reason, the communication system of the present disclosure can prevent the first controller staying in the wake-up mode with the power switch in the connected state even though the first controller is allowed to stop operating by setting the power switch to the disconnected state. Thus, the first controller can avoid wasting electric power and the communication system can reduce power consumption.

Yet another aspect of the present disclosure is a communication system including power switches, a first controller, and a second controller. Each of the power switches is configured to selectively switch between a connected state in which a power supply path is electrically connected to a power source and a disconnected state in which the power supply path is electrically disconnected from the power source. The first controller receives electric power from the power source through at least one of the power switches. The second controller is communicatively connected to the first controller for data communication and configured to control the power switches.

The second controller includes a state information transmitting unit. The state information transmitting unit is configured to transmit switch state information to the first controller. The switch state information indicates that each of the power switches is in the connected state or the disconnected state.

The first controller includes a disconnection transition unit. The disconnection transition unit is configured to put the first controller into a stop mode or a sleep mode when the switch state information, which is received from the second controller, indicates all the power switches are in the disconnected state or all the power switches except for the at least one of the power switches connected to the first controller are in the disconnected state.

The communication system of the present disclosure configured in this manner can prevent abnormal situations in which the first controller keeps operating with all the power switches in the disconnected state or with all the power switches except the at least one of the power switches connected to the first controller in the disconnected state. Thus, the communication system can prevent the first controller from wasting electric power and reduce power consumption.

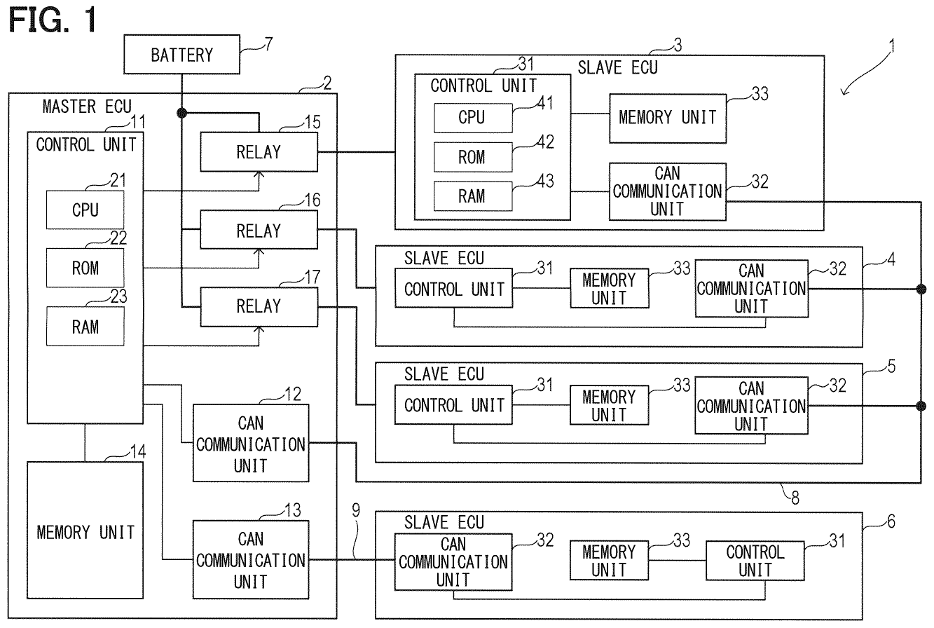

(First Embodiment) The following describes a first embodiment of the present disclosure with reference to the drawings. The communication system 1 of the present embodiment is mounted in a vehicle, and includes a master ECU 2, slave ECUs 3, 4, 5, and 6, and a battery 7, as shown in FIG. 1. ECU is an abbreviation for Electronic Control Unit. Hereinafter, the master ECU 2 and the slave ECUs 3 to 6 will be collectively referred to as nodes.

The master ECU 2 and the slave ECUs 3, 4, and 5 are connected to each other via a communication bus 8 so as to be capable of data communication. The master ECU 2 and the slave ECU 6 are connected to each other via a communication bus 9 so as to be capable of data communication.

The battery 7 supplies electric power to various parts of the vehicle at a DC battery voltage (for example, 12 V). The master ECU 2 and the slave ECUs 3 to 6 operate by receiving the electric power from the battery 7.

The master ECU 2 includes a control unit 11, CAN communication units 12 and 13, a memory unit 14, and relays 15, 16, and 17. CAN is an abbreviation for Controller Area Network. The communication protocol of the communication system 1 is not limited to CAN.

The control unit 11 is an electronic control device mainly including a microcontroller with a CPU 21, a ROM 22, and a RAM 23. Various functions of the microcontroller are implemented by the CPU 21 executing a program stored in a non-transitory tangible storage medium. In this example, the ROM 22 corresponds to the non-transitory tangible storage medium storing the program. A method corresponding to the program is executed by executing the program. A part or all of the functions to be executed by the CPU 21 may be configured as hardware circuitry by one or multiple ICs or the like. The number of microcontrollers included in the control unit 11 may be one or more.

The CAN communication unit 12 communicates with the slave ECUs 3, 4, and 5 connected through the communication bus 8 by transmitting and receiving communication frames based on the CAN communication protocol. The CAN communication unit 13 communicates with the slave ECU 6 connected through the communication bus 9 by transmitting and receiving communication frames based on the CAN communication protocol. Hereinafter, the CAN communication frame will be referred to as a CAN frame.

The memory unit 14 is a storage device for storing various data. The memory unit 14 stores a management table 25, which will be described later. The relay 15 is arranged on a power supply path between the battery 7 and the slave ECU 3. The relay 16 is arranged on a power supply path between the battery 7 and the slave ECU 4. The relay 17 is arranged on a power supply path between the battery 7 and the slave ECU 5.

Each of the relays 15, 16, and 17 is configured to switch between a connected state in which the power supply path is electrically connected to the battery 7 and a disconnected state in which the power supply path is electrically disconnected from the battery 7 according to a command from the control unit 11. Hereinafter, the connected state will be referred to as an on state, and the disconnected state will be referred to as an off state.

Each of the slave ECUs 3 to 6 includes a control unit 31, a CAN communication unit 32, and a memory unit 33. The control unit 31 is an electronic control device mainly including a microcontroller with a CPU 41, a ROM 42, and a RAM 43. Various functions of the microcontroller are implemented by causing the CPU 41 to execute program codes stored in a non-transitory tangible storage medium. In this example, the ROM 42 corresponds to a non-transitory tangible storage medium that stores a program. In addition, by executing this program, a method corresponding to the program is executed. Note that a part or all of the functions to be executed by the CPU 41 may be configured as hardware circuitry by one or multiple ICs or the like. Alternatively, the number of the microcomputers constituting the control unit 31 may be one or more.

The CAN communication units 32 of the slave ECUs 3 to 5 communicate with communication devices (that is, the master ECU 2 and the slave ECUs 3 to 5) connected to the communication bus 8 based on a CAN communication protocol.

The CAN communication unit 32 of the slave ECU 6 communicates with a communication device (that is, the master ECU 2) connected to the communication bus 9 based on a CAN communication protocol. The memory unit 33 is a storage device for storing various data.

The CAN frame includes a start of frame, an arbitration field, a control field, a data field, a CRC field, an ACK field, and an end of frame.

The arbitration field consists of an 11-bits or 29-bits identifier (i.e., ID) and a 1-bit RTR.

An 11-bit identifier used in CAN communication is referred to as a CANID. The CANID is predetermined based on data contents of the CAN frame, the source of the CAN frame, the destination of the CAN frame, and the like.

The data field is a payload including first data, second data, third data, fourth data, fifth data, sixth data, seventh data, and eighth data each of which has 8 bits (i.e., one byte).

Each of the master ECU 2 and the slave ECUs 3 to 6 is configured to switch between a wake-up mode (i.e., an active state) and a sleep mode (i.e., a dormant state). The wake-up mode is a normal operating state in which the functions assigned to the ECU are available without restriction. The sleep mode is a low power consumption state with limited functions available. In the sleep mode, many functions are stopped to save power, and only some functions (for example, the function of receiving CAN frames) are available.

The communication system 1 forms a partial network, which is an electric power supply control method based on communication control of the CAN protocol standard defined in ISO11898-6. Thus, the communication system 1 selectively causes communication groups including at least one node to enter a wake-up mode or a sleep mode. The communication system 1 causes the at least one node belonging to the communication group all together to enter the wake-up mode or the sleep mode. Thereby, the communication system 1 achieves low electric power consumption.

The communication system 1 uses an NM frame, which is a CAN frame including activation information for specifying an activation group, when waking up a node in the sleep mode. NM is an abbreviation for Network Management.

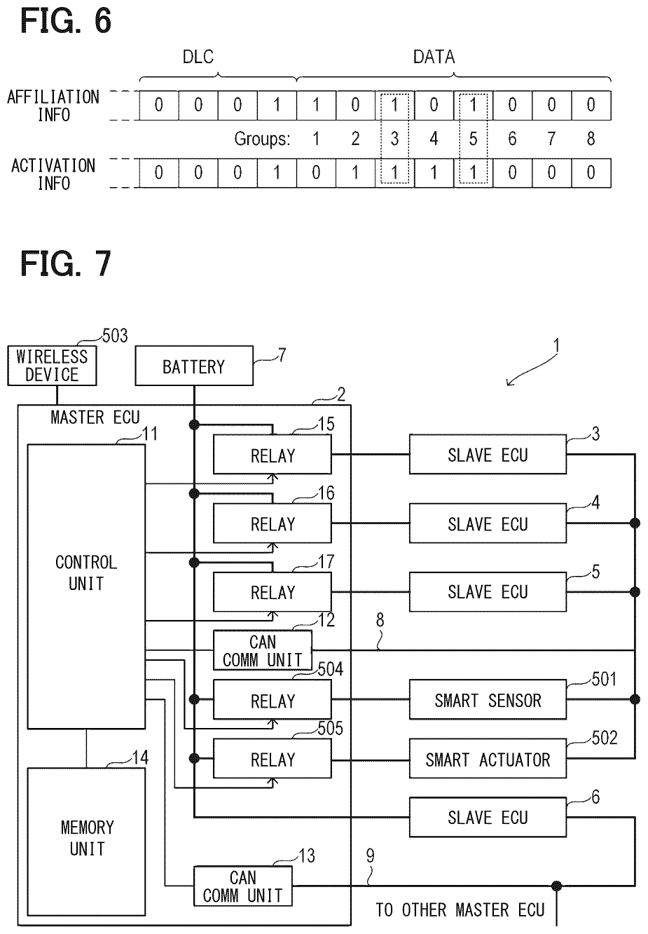

The activation information is set as shown in FIG. 6, for example. DLC stands for Data Length Code, and is a region representing the size of a data field in a CAN frame in byte units. That is, the activation information is stored in the data field of the CAN frame. Here, in order to simplify the explanation, a case where the DLC is 1 byte (i.e., 8 bits) is shown. Activation groups are assigned respectively to bits of 8-bit data representing the activation information.

In the activation information set in the NM frame, a bit corresponding to the activation group to be activated is set to 1. Each node stores affiliation information indicating at least one activation group to which the own node belongs. The affiliation information has the same data length as the activation information, and the assignment of bits of the affiliation information is also the same as that of the activation information. In the affiliation information, the bit corresponding to the activation group to which the own node belongs is set to 1.

Each node determines whether the communication group to which the own node belongs is a target for activation by comparing the activation information extracted from the NM frame and the affiliation information stored in the own node.

For example, the affiliation information shown in FIG. 6 indicates that the node belongs to the first communication group, the third communication group, and the fifth communication group. The activation information shown in FIG. 6 indicates that the second communication group, the third communication group, the fourth communication group, and the fifth communication group are targets for activation. Since both of the affiliation information and the activation information indicate the third communication group and the fifth communication group as shown in FIG. 6, the node determines that the own node is a target for activation as the third communication group and the fifth communication group.

The management table 25 shown in FIG. 1 sets, for each of multiple communication groups, a correspondence between the communication group and at least one node (that is, at least one node to be activated) belonging to the corresponding communication group.

The management table 25 sets, for example, that the master ECU 2 and the slave ECUs 3 and 4 belong to the first communication group. The management table 25 sets, for example, that the slave ECUs 3, 4, and 5 belong to the second communication group.

In addition, each of the master ECU 2 and slave ECUs 3 to 6 is configured to, when detecting that a start condition of an event is satisfied, generate and transmit an NM frame including, as the activation information, information indicating a communication group related to the event.

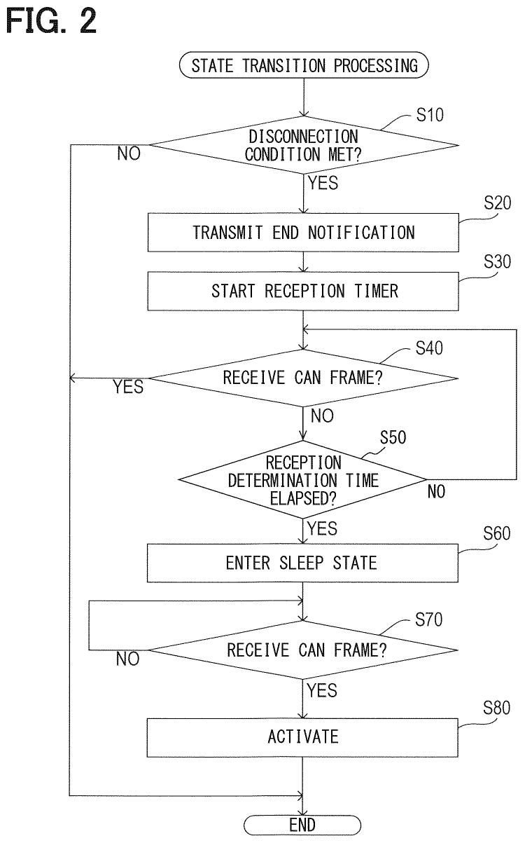

Next, the procedure of state transition processing executed by the control units 31 of the slave ECUs 3 to 5. The state transition processing is repeatedly executed during the slave ECUs 3 to 5 operating. When the state transition processing is executed, the CPU 41 of the control unit 31 determines whether a predetermined disconnection condition is met in S10, as shown in FIG. 2. The disconnection condition in this embodiment includes a condition that the slave ECUs 3 to 5 are allowed to enter the sleep mode from the wake-up mode. That is, the disconnection condition is met when each of the slave ECUs 3 to 5 no longer needs to control their targets.

For example, when the control target of the slave ECU 3 is an in-vehicle air conditioner and a vehicle occupant turns off the in-vehicle air conditioner, the slave ECU 3 no longer needs to control the in-vehicle air conditioner. This is the situation in which the slave ECU 3 is allowed to enter the sleep mode from the wake-up mode, thus the disconnection condition of the slave ECU 3 is met.

In the present embodiment, the disconnection condition of the slave ECU 3 includes a low voltage condition. In other words, the disconnection conditions of the slave ECUs 4 and 5 do not include the low voltage condition. The low voltage condition is that the voltage of the battery 7 falls below a predetermined disconnection determination value. That is, when the voltage of the battery 7 is less than the disconnection determination value, the disconnection condition is met.

Here, when the disconnection condition is not met, the CPU 41 ends the state transition processing. On the other hand, when the disconnection condition is met, the CPU 41 transmits, in S20, to the master ECU 2 an end notification indicating that the relay connected to the own node is allowed to switch to the disconnected state. When the master ECU 2 receives the end notification, the master ECU 2 switches the relay corresponding to the received end notification to the disconnected state after a waiting period predetermined for the slave ECU, which has transmitted the end notification, has elapsed, for example. This waiting period is set for each slave ECU to be longer than the time required for the slave ECU to execute various processes before entering the sleep mode and completing the transition to the sleep mode. For example, when the master ECU 2 receives the end notification from the slave ECU 3, the master ECU 2 sets the relay 15 to the disconnected state after the predetermined waiting period for the slave ECU 3 has elapsed.

The CPU 41 starts a reception timer provided in the RAM 43 in S30. The reception timer is a timer that increments, for example, every 1 ms. When the reception timer is started, its value increments from 0 (i.e., 1 is added to the value).

In S40, the CPU 41 determines whether a CAN frame addressed to the own node has been received. If the CPU 41 receives a CAN frame addressed to the own node, the CPU 41 ends the state transition processing. On the other hand, if the CPU 41 has not received a CAN frame addressed to the own node, the CPU 41 determines in S50 whether a predetermined reception determination period has elapsed. Specifically, the CPU 41 determines whether the value of the reception timer is equal to or greater than a value corresponding to the reception determination period.

When the reception determination period has not elapsed, the CPU 21 moves the processing to S40. On the other hand, if the reception determination period has elapsed, the CPU 41 executes in S60 various end processes before entering the sleep mode, and shifts the own node to the sleep mode after the various end processes are completed.

In S70, the CPU 41 determines whether a CAN frame has been received. The CPU 41 determines that a CAN frame has been received not only when a CAN frame addressed to the own node has been received but also when a CAN frame addressed to another node has been received.

Here, when a CAN frame has not been received, the CPU 41 repeats the processing of S70 and waits until the CAN frame is received. Then, when the CAN frame is received, the CPU 41 activates the own node (that is, shifts the own node to the wake-up mode) in S80, and ends the state transition processing.

The slave ECUs 3, 4, and 5 described above are configured to receive electric power from the battery 7 via the relays 15, 16, and 17 that are configured to switch between the connected state in which the power supply path is electrically connected to the battery 7 and the disconnected state in which the power supply path is electrically disconnected from the battery 7.

The slave ECUs 3, 4, and 5 are configured to transmit an end notification to the master ECU 2 when a predetermined disconnection condition is met, which indicates that the relays 15, 16, and 17 connected to the slave ECUs 3, 4, and 5 is allowed to switch to the disconnected state. The master ECU 2 is connected to the slave ECUs 3, 4, and 5 for data communication, and is configured to exchange CAN frames with the slave ECUs 3, 4, and 5. The master ECU 2 is configured to control the relays 15, 16, and 17.

The slave ECUs 3, 4, and 5 are configured to enter the sleep mode if the predetermined reception determination period has elapsed since the disconnection condition was met and if the slave ECUs 3, 4, and 5 do not receive a CAN frame addressed to its own node during the reception determination period from all of the multiple communication devices (i.e., the master ECU 2 and the slave ECUs 3, 4, and 5) connected to the slave ECUs 3, 4, and 5 for data communication.

Such slave ECUs 3, 4, and 5 can enter the sleep mode even if a malfunction occurs in which the master ECU 2, having received an end notification from the slave ECUs 3, 4, and 5, fails to switch the relays 15, 16, and 17 to the disconnected state. As a result, the slave ECUs 3, 4, and 5 can avoid staying in the wake-up mode with the relays 15, 16, and 17 in the connected state even through the slave ECUs 3, 4, and 5 are allowed to stop operating by setting the relays 15, 16, and 17 to the disconnected state. Thus, the slave ECUs 3, 4, and 5 can avoid wasting electric power, thereby reducing the power consumption in the communication system 1.

Each of the slave ECUs 3, 4, and 5 is configured to enter the wake-up mode when each of the slave ECUs 3, 4, and 5 in the sleep mode receives a CAN frame from at least one of communication devices (i.e., at least one of the master ECU 2 and the slave ECUs 3, 4, and 5). That is, each of the slave ECUs 3, 4, and 5 enters the wake-up mode when each of the slave ECUs 3, 4, and 5 needs to execute processing. Thus, the communication system 1 can cause the slave ECUs 3, 4, and 5 to execute necessary processing promptly.

When each of the slave ECUs 3, 4, and 5 does not receive a CAN frame addressed to the own node, each of the slave ECUs 3, 4, and 5 enters the sleep mode. Thus, the slave ECU 3, 4, and 5 can enter the sleep mode when the slave ECU 3, 4, and 5 receive a CAN frame addressed to the node except the own node, which further reduces the power consumption in the communication system 1.

The disconnection condition of the slave ECU 3 includes the low voltage condition indicating that the voltage of the battery 7 falls below a predetermined disconnection determination value. This allows the slave ECU 3, which executes processing of low importance, can enter the sleep mode when the battery voltage is low. Therefore, the slave ECU 3 can avoid executing processing of low importance during the low battery voltage and avoid further consuming the low battery voltage. This enables the slave ECUs 4 and 5 to execute processing of high importance even during the low battery voltage.

The communication system includes slave ECUs 3, 4, and 5 and a master ECU 2. The slaves ECU 3, 4, and 5 receive electric power from the battery 7 respectively via the relays 15, 16, and 17 each of which is configured to switch between the connected state in which the power supply path is electrically connected to the battery 7 and the disconnected state in which the power supply path is electrically disconnected from the battery 7. The master ECU 2 is connected to the slave ECUs 3, 4, and 5 for data communication, and is configured to exchange CAN frames with the slave ECUs 3, 4, and 5 and control the operation of the relays 15, 16, and 17.

The slave ECUs 3, 4, and 5 are configured to transmit an end notification to the master ECU 2 when a predetermined disconnection condition is met, which indicates that the relays 15, 16, and 17 connected to the slave ECUs 3, 4, and 5 is allowed to switch to the disconnected state.

The slave ECUs 3, 4, and 5 are configured to enter the sleep mode if the predetermined reception determination period has elapsed since the disconnection condition was met and if the slave ECUs 3, 4, and 5 do not receive a CAN frame addressed to the own node from all of the multiple communication devices (i.e., the master ECU 2 and the slave ECUs 3, 4, and 5) connected to the slave ECUs 3, 4, and 5 for data communication during the reception determination period.

The communication system 1 includes the slave ECUs 3, 4, and 5, and thus can obtain similar effects as those of the slave ECUs 3, 4, and 5. In the embodiment described above, each of the relays 15, 16, and 17 corresponds to a power switch, the battery 7 corresponds to a power source, each of the slave ECUs 3, 4, and 5 corresponds to an electronic controller or a first controller, the CAN frame corresponds to a communication frame, the master ECU 2 corresponds to a power supply controller or a second controller.

Moreover, processing of S10 and S20 corresponds to processing performed by the end notification unit, processing from S30 through S60 corresponds to processing performed by the sleep transition unit, and processing from S70 through S80 corresponds to processing performed by the wake-up transition unit.

(Second Embodiment) The following describes a second embodiment of the present disclosure with reference to the drawings. In the second embodiment, portions different from the first embodiment will be described. Common configurations are denoted by the same reference numerals.

The communication system 1 of the second embodiment differs from the first embodiment in state transition processing and in that the master ECU 2 executes state transmission processing. Next, the procedure of the state transmission processing executed by the control unit 11 of the master ECU 2 will be described. The state transmission processing is repeatedly executed while the master ECU 2 is operating.

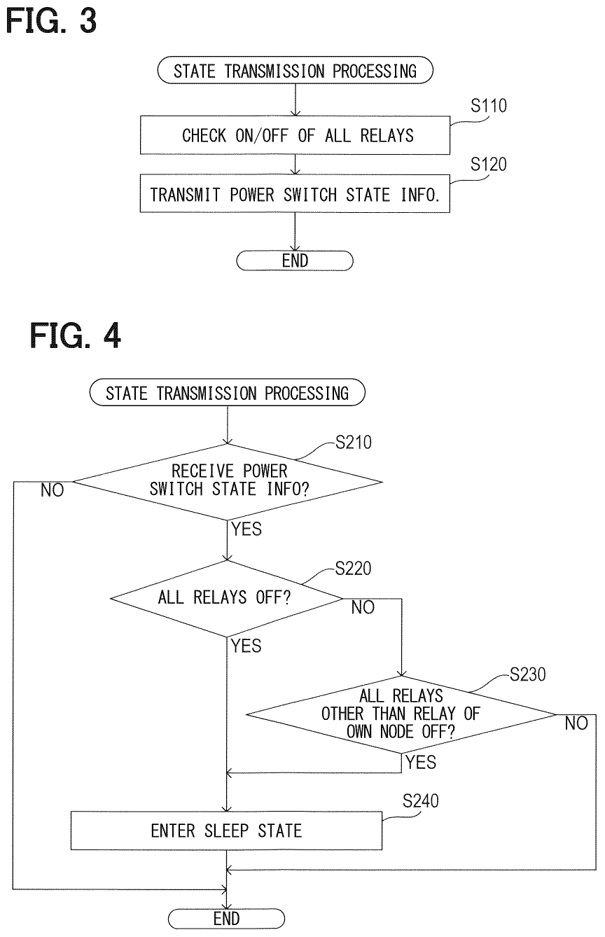

When the state transmission processing is executed, the CPU 21 of the control unit 11 checks in S110 whether each of the relays 15, 16, and 17 is in the on state (i.e., the connected state) or the off state (i.e., the disconnected state), as shown in FIG. 3. Specifically, the CPU 21 first detects the value of the current flowing through the power supply path in which each of the relays 15, 16, and 17 is arranged (hereinafter, referred to as a relay current value). When the detected relay current value is equal to or greater than a predetermined on-determination value, the CPU 21 determines that the corresponding relay is in the on-state, and when the detected relay current value is less than the on-determination value, the CPU 21 determines that the corresponding relay is in the off-state.

In S120, the CPU 21 transmits switch state information indicating whether each of the relays 15, 16, 17 is in the on state or the off state based on the check results in S110 to the slave ECUs 3 to 5, and ends the state transmission processing.

Next, the procedure of the state transition processing according to the second embodiment will be described. When the state transition processing of the second embodiment is performed, the CPU 41 of the control unit 31 in S210 determines whether the switch state information is received from the master ECU 2 as shown in FIG. 4.

When no switch state information has been received, the CPU 41 ends the state transition processing. On the other hand, when having received the switch state information, the CPU 41 in S220 determines whether all the relays (i.e., the relays 15, 16, and 17) are in the off state based on the received switch state information. When all the relays 15, 16, and 17 are in the off state, the CPU 41 shifts the processing to S240.

On the other hand, when at least one of the relays 15, 16, 17 is in the on state, the CPU 41 shifts the processing to S230 and determines in S230 whether all the relays except the own node are in the off state. For example, when the own node is the slave ECU 3, the CPU 41 determines that all of the relays except the own node is off state when the relay 15 is in the on state and the relays 16 and 17 are in the off state.

If there is a relay in the on state except the relay of the own node, the CPU 41 ends the state transition processing. On the other hand, if all the relays except the relay of the own node are in the off state, the CPU 41 shifts the processing to S240.

In S240, the CPU 41 shifts the own node to the sleep mode, and ends the state transition processing. The slave ECUs 3, 4, and 5 described above are configured to receive electric power from the battery 7 via the relays 15, 16, and 17 that are configured to switch between the connected state in which the power supply path is electrically connected to the battery 7 and the disconnected state in which the power supply path is electrically disconnected from the battery 7.

Each of the slave ECUs 3, 4, and 5 is configured to enter the sleep mode when the switch state information received from the master ECU 3 indicates that all of the relays 15, 16 and 17 are in the off state or that all of the relays except the relay connected to the slave ECUs 3, 4, and 5 are in the off state. The master ECU 2 is connected to the slave ECUs 3, 4, and 5 for data communication and configured to control the relays 15, 16, and 17. The switch state information indicates whether each of the relays 15, 16, and 17 is in the connected state or the disconnected state.

Such slave ECUs 3, 4, 5 can avoid keeping operating even in an abnormal situation where all the relays 15, 16, and 17 are in the disconnected state or where all the relays except the relay 15, 16, 17 connected to the slave ECUs 3, 4, 5 are in the disconnected state. Thus, the slave ECUs 3, 4, 5 can avoid wasting electric power, which reduces the power consumption in the communication system 1. It should be noted that a state in which all the relays 15, 16, and 17 are in the disconnected state and a state in which only one of the relays 15, 16, and 17 is in the connected state indicates a malfunction.

The communication system 1 includes the relays 15, 16, and 17, the slave ECUs 3, 4, and 5, and the master ECU 2. Each of the relays 15, 16, and 17 is configured to switch between the connected state in which the power supply path is electrically connected to the battery 7 and a disconnected state in which the power supply path is electrically disconnected from the battery 7. The slave ECUs 3, 4, and 5 receive electric power from the battery 7 respectively via the relays 15, 16, and 17. The master ECU 2 is connected to the slave ECUs 3, 4, and 5 for data communication and configured to control the relays 15, 16, and 17.

The master ECU 2 is configured to transmit, to the slave ECUs 3, 4, and 5, switch state information indicating whether each of the relays 15, 16, and 17 is in the connected state or the disconnected state.

Each of the slave ECUs 3, 4, and 5 is configured to enter the sleep mode when the switch state information received from the master ECU 2 indicates that all of the relays 15, 16, and 17 are in the disconnected state, or that all of the relays except the relay connected to the corresponding slave ECU 3, 4, and 5 are in the disconnected state.

The communication system 1 includes the slave ECUs 3, 4, and 5, and thus can obtain similar effects as those of the slave ECUs 3, 4, and 5. In the embodiment described above, the relays 15, 16, and 17 correspond to power switches, processing of S120 corresponds to the processing performed by the state information transmitting unit, and processing from S220 through S240 corresponds to the processing performed by the disconnection transition unit.

(Third Embodiment) The following describes a third embodiment of the present disclosure with reference to the drawings. In the third embodiment, portions different from those of the first embodiment will be described. Common configurations are denoted by the same reference numerals.

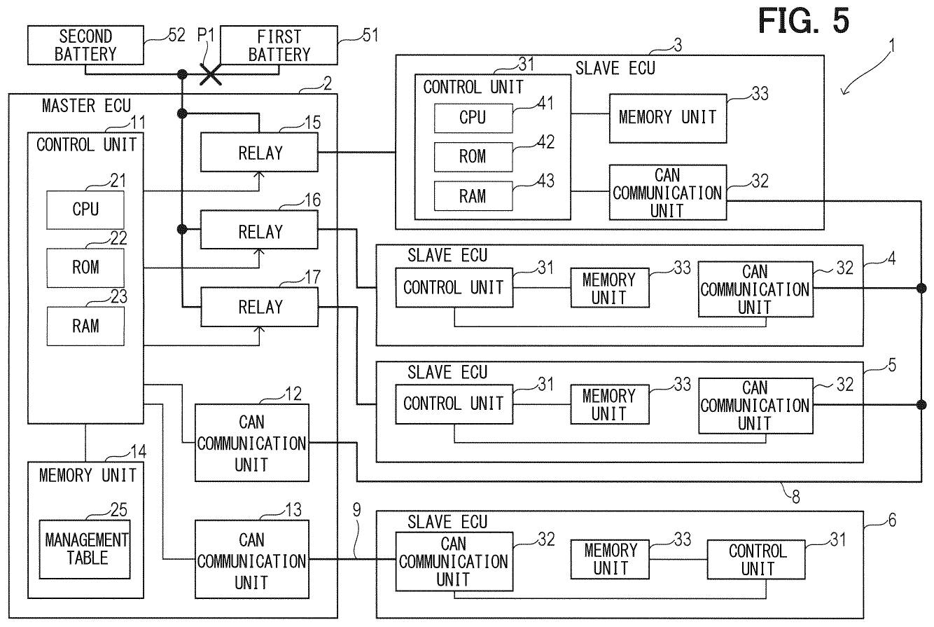

As shown in FIG. 5, the communication system 1 of the third embodiment differs from the first embodiment in that a first battery 51 and a second battery 52 are provided instead of the battery 7. The first battery 51 supplies power to the slave ECUs 3, 4, and 5 via the relays 15, 16, and 17 at a DC battery voltage.

The second battery 52 supplies power to the slave ECUs 3, 4, and 5 via the relays 15, 16, and 17 at a DC battery voltage. The master ECU 2 has a first disconnection detection function that detects whether a disconnection exists in the power supply path between the first battery 51 and the relays 15, 16, and 17, and a second disconnection detection function that detects whether a disconnection exists in the power supply path between the second battery 52 and the relays 15, 16, and 17. For example, a disconnection location P1 in FIG. 5 indicates that a disconnection exists in the power supply path from the first battery 51 to the relays 15, 16, and 17.

The communication system 1 of the third embodiment also differs from the first embodiment in the state transition processing of the slave ECU 3. The state transition processing of the slave ECU 3 in the third embodiment is different from that of the first embodiment in the disconnection condition in S10.

That is, in the state transition processing of the third embodiment, the CPU 41 determines in S10 whether the disconnection condition of the third embodiment is met. The disconnection conditions of the third embodiment include a power supply malfunction condition, which will be described later, in addition to the disconnection condition of the first embodiment. That is, when at least one of the disconnection conditions in the first embodiment or a power supply malfunction condition described later is satisfied, the disconnection condition in the third embodiment is satisfied. The power supply malfunction condition is that a disconnection in the power supply path is detected by the first disconnection detection function or the second disconnection detection function. The slave ECU 3 includes the power supply malfunction condition as the disconnection condition because the slave ECU 3 executes processing of low importance.

Here, when the disconnection condition is not met, the CPU 41 ends the state transition processing. On the other hand, when the disconnection condition is met, the CPU 41 shifts the processing to S20. In this embodiment, the state transition processing executed by the slave ECUs 4 and 5 does not include the power supply malfunction condition in S10.

The disconnection condition for the slave ECU 3 configured in this manner includes the power supply malfunction condition that a malfunction exists in the power supply from the first battery 51 or the second battery 52 to the slave ECUs 3, 4, and 5. Thus, the slave ECU 3 which executes processing of low importance can enter the sleep mode when the power supply capacity to the slave ECUs 3, 4, and 5 has decreased. The slave ECU 3 avoids executing processing of low importance while the power supply capacity is low, which avoids further consuming the power supply capacity. Thus, the slave ECUs 4 and 5 can execute processing of high importance even while the power supply capacity is low.

In the embodiment described above, the first battery 51 and the second battery 52 correspond to the power source.

[Fourth embodiment] The fourth embodiment of the present disclosure will be described with reference to the drawings. In the fourth embodiment, portions different from those of the first embodiment will be described. Common configurations are denoted by the same reference numerals.

As illustrated in FIG. 7, the communication system 1 of the fourth embodiment differs from the first embodiment in that a smart sensor 501, a smart actuator 502, a wireless device 503, and relays 504 and 505 are added.

The smart sensor 501 is a sensor equipped with a communication function. The smart sensor 501 is connected to the communication bus 8. The smart actuator 502 is an actuator equipped with a communication function. The smart actuator 502 is connected to the communication bus 8.

The wireless device 503 is a wireless communication device for performing wireless communication with an external communication device installed outside the vehicle. The wireless device 503 is, for example, a DCM. DCM stands for Data Communication Module.

The relay 504 is disposed on a power supply path between the battery 7 and the smart sensor 501. The relay 505 is disposed on a power supply path between the battery 7 and the smart actuator 502.

The relays 504 and 505 are configured to switch between the connected state in which the power supply path is electrically connected to the power source and the disconnected state in which the power supply path is electrically disconnected from the power source in accordance with an instruction from the control unit 11. Hereinafter, the master ECU 2, the slave ECUs 3 to 6, the smart sensor 501, and the smart actuator 502 will be collectively referred to as nodes.

(Prerequisite) The master ECU 2 and the slave ECU 6 are always supplied with the electric power by the battery 7 without passing through a relay, and can independently switch between the wake-up mode and the sleep mode by themselves. Hereinafter, the master ECU 2 and the slave ECU 6 are also referred to as NM-equipped nodes. An NM-equipped node is a node having a function of generating an NM frame.

The slave ECUs 3 to 5, the smart sensor 501, and the smart actuator 502 are supplied with the electric power via a relay, and cannot independently switch to a wake-up mode or a sleep mode by themselves. That is, the wake-up mode is established when the relay is turned on, and the sleep mode is established when the relay is turned off. Hereinafter, the slave ECUs 3, 4, 5, the smart sensor 501, and the smart actuator 502 are also referred to as NM-non-equipped nodes. The NM-non- equipped node is a node that does not have the functions to generate and interpret a NM frame.

The NM-non-equipped node includes at least one of an actuator and a sensor in addition to an ECU having a control function. The power supply paths of the NM-non-equipped nodes are connected to the relays 15, 16, 17, 504, and 505 of the master ECU 302, respectively.

The NM-non-equipped nodes and the relays may be connected one-to-one, or multiple NM-non-equipped nodes belonging to the same cluster (i.e., a group that is activated simultaneously) may be connected to a single relay.

The master ECU 2 and the NM-equipped node have a CAN communication unit and are capable of transmitting and receiving a NM frame. The NM-equipped node determines whether own node is in the wake-up mode or the sleep mode based on an NM frame transmitted and received via the communication bus.

The master ECU 2 switches the relays 15, 16, 17, 504, and 505 to which the NM-non-equipped nodes are connected between the on state and the off state based on the NM frame transmitted and received via the communication bus.

The payload (i.e., data area) of an NM frame transmitted and received by the master ECU 2 and the NM-equipped node stores one or more bits of information indicating which cluster to activate.

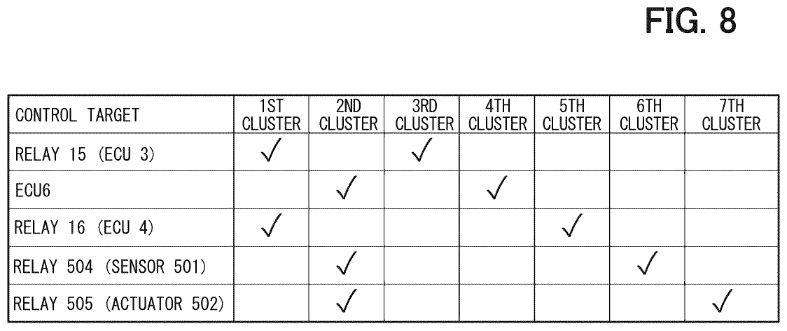

The vehicle includes at least one master ECU (i.e., ECU with built-in a relay). As shown in FIG. 8, at least one node belonging to each cluster is determined in advance by the system developer. Although it is possible to assign a cluster to each node, multiple nodes can be assigned to one cluster. If the bit corresponding to each cluster is active (i.e., “bit”=1), the cluster wakes up. From the view of the master ECU, waking up indicates turning on the relay.

(First activation example) The first activation example is an operation example in which a malfunction diagnosis of the slave ECU 3 is performed based on a request from the cloud.

First, the wireless device 503 receives a connection request from the base station (i.e., the cloud). Next, when the wireless device 503 determines that the connection request is proper, the wireless device 503 notifies the master ECU 2 of the event received from the cloud.

Next, the master ECU 2 determines a service defined as “malfunction diagnosis of the slave ECU 3” based on the event, and generates an NM frame in which the bit of the third cluster to which only the slave ECU 3 belongs is active in order to activate the slave ECU 3.

Next, the master ECU 2 transmits the generated NM frame onto the communication buses 8 and 9. Since there is no NM-equipped node belonging to the third cluster on the communication buses 8 and 9, there is no change in the devices on the communication buses.

Next, the master ECU 2 executes processing based on the NM frame in the control unit 11, assuming that the master ECU has received an NM frame in which the bit of the third cluster is active at the same time as transmitting the NM frame. Next, the control unit 11 of the master ECU 2 determines a wake-up instruction to the third cluster based on the NM frame. Since the third cluster includes the relay 15, the control unit 11 turns on the relay 15.

When the relay 15 is switched to the on state, the electric power is supplied to the downstream slave ECU 3 and the slave ECU 3 is activated. The master ECU 2 waits for the slave ECU 3 to be activated, requests the slave ECU 3 for a diagnosis code, and transmits a response result from the slave ECU 3 to the base station via the wireless device 503.

(Second activation example) The second activation example is an operation example in which a malfunction diagnosis of the slave ECU 6 is performed based on a request from the cloud.

First, the wireless device 503 receives a connection request from the base station (i.e., the cloud). Next, when the wireless device 503 determines that the connection request is proper, the wireless device 503 notifies the master ECU 2 of the event received from the cloud.

Next, the master ECU 2 determines a service defined as “malfunction diagnosis of the slave ECU 6” based on the event, and generates an NM frame in which the bit of the fourth cluster to which only the slave ECU 6 belongs is active in order to activate the slave ECU 6.

Next, the master ECU 2 transmits the generated NM frame onto the communication buses 8 and 9. Since the slave ECU 6 is disposed on the communication bus 6 as a node belonging to the fourth cluster, the slave ECU 6 wakes up.

Next, the master ECU 2 executes processing based on the NM frame in the control unit 11, assuming that the master ECU 2 has received an NM frame in which the bit of the fourth cluster is active at the same time as transmitting the NM frame. Next, even if the control unit 11 of the master ECU 2 determines to issue a wake-up instruction to the fourth cluster based on the NM frame, the fourth cluster does not include the corresponding relay, so the control unit 11 ignores the instruction.

When the slave ECU 6 is activated, the master ECU 2 requests the slave ECU 6 for a diagnostic code via the communication bus, and transmits a response result from the slave ECU 6 to the base station via the wireless device 503.

(Third activation example) The third activation example is an operation example in which remote air conditioning is activated using a smartphone by a user. First, the user issues an instruction to turn on the in-vehicle air conditioner via the smartphone.

When the wireless device 503 receives an instruction signal from the smartphone and determines that the instruction signal is proper, the wireless device 503 transmits the event (i.e., the instruction signal) received from the cloud to the master ECU 2.

The master ECU 2 determines the “air conditioning service” based on the event, and generates an NM frame in which the second cluster is activated as the air conditioning cluster. The master ECU 2 periodically transmits the generated NM frames to the communication buses 8 and 9 until an instruction to stop the air conditioner is received. If the user requests to continue the active state, it is necessary for the master ECU 302 to continue transmitting the NM frames periodically. At the same time, the control unit 11 of the master ECU 2 executes a process based on the NM frame.

When an NM frame in which the second cluster is active occurs on the communication bus 9, the slave ECU 6 (i.e., the air conditioner ECU) belonging to the second cluster receives the NM frame and wakes up in accordance with the received NM frame.

When the control unit 11 of the master ECU 2 detects that the second cluster is active, the control unit 11 turns on the relays 504 and 505 that belong to the second cluster. When the relays 504 and 505 are switched to the on state, the electric power is supplied to the smart sensor 501 (i.e., the temperature sensor) and the smart actuator 502 (i.e., the compressor).

As a result of the above, the electric power is supplied to the air conditioner ECU, the smart sensor 501, and the smart actuator 502, thereby turning on the in- vehicle air conditioner. When the user issues an instruction to turn off the in-vehicle air conditioner from the smartphone, the master ECU 2 stops the periodic transmission of the NM frame.

When the NM frame is interrupted, the slave ECU 6 transitions to the sleep mode, and the master ECU 2 turns off the relays 504 and 505. Thus, the in-vehicle air conditioner stops operating.

(Fourth activation example) The fourth activation example is an operation example in which the slave ECU 6 activates the in-vehicle air conditioner. The slave ECU 6 is continuously supplied with the electric power even when the vehicle is stopped. Thus, the slave ECU 6 can wake up by detecting signals indicating that an activation switch connected to the slave ECU 6 is turned on even in the sleep mode.

When the slave ECU 6 in the wake-up mode confirms an input to activate the in-vehicle air conditioner, the slave ECU 6 generates an NM frame in which the bit corresponding to the second cluster is turned on. The slave ECU 6 transmits the generated NM frame via the CAN communication unit 32. When the master ECU 2 receives this NM frame, the master ECU 2 turns on the relays 504 and 505 that belong to the second cluster.

When the activation switch of the in-vehicle air conditioner is turned off, the slave ECU 6 stops transmitting the NM frame and transitions to the sleep mode after a while. When the NM frame is interrupted, the master ECU 2 turns off the relays 504 and 505 after a while and ends the control.

When the master ECU 2 determines that it is necessary to continue the control even after the transmission of the NM frame has stopped, the master ECU 2 transmits NM frames in which the bit corresponding to the second cluster is turned on. Thus, the slave ECU 6 and the relays 504 and 505 can maintain the activation state until the transmission of the NM frame generated by the master ECU 2 stops.

(Fifth Embodiment) The following describes a fifth embodiment of the present disclosure with reference to the drawings. In the fifth embodiment, portions different from those of the first embodiment will be described.

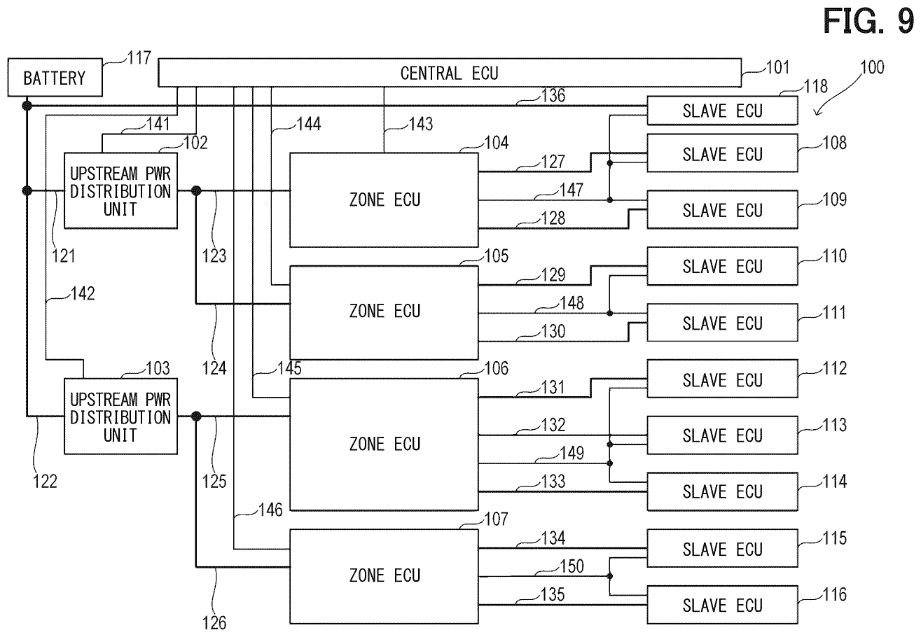

The communication system 100 of the fifth embodiment is mounted on a vehicle and, as shown in FIG. 9, includes a central ECU 101, upstream power distribution units 102, 103, zone ECUs 104, 105, 106, 107, slave ECUs 108, 109, 110, 111, 112, 113, 114, 115, 116, a battery 117, and a slave ECU 118. In the following description, the central ECU 101, the zone ECUs 104 to 107, and the slave ECUs 108 to 116 and 118 are collectively referred to as nodes. Here, the zone ECU may be an ECU that bundles slave ECUs located in a predetermined area within the vehicle, or an ECU that bundles slave ECUs that belong to a predetermined domain.

The battery 117 supplies electric power to various parts of the vehicle at a DC battery voltage (for example, 12 V). The central ECU 101, the upstream power distribution units 102 and 103, the zone ECUs 104 to 107, and the slave ECUs 108 to 116 and 118 operate with the electric power from the battery 117.

The upstream power distribution unit 102 receives the electric power from the battery 117 via a power supply path 121 between the battery 117 and the upstream power distribution unit 102. The upstream power distribution unit 103 receives the electric power from the battery 117 via a power supply path 122 between the battery 117 and the upstream power distribution unit 103.

The zone ECUs 104 and 105 receive the electric power from the battery 117 via power supply paths 123 and 124 between the upstream power distribution unit 102 and the zone ECUs 104 and 105, respectively.

The zone ECUs 106 and 107 receive the electric power from the battery 117 via the power supply paths 125 and 126 between the upstream power distribution unit 103 and the zone ECUs 106 and 107, respectively.

The slave ECUs 108 and 109 receive the electric power from the battery 117 via the power supply paths 127 and 128 between the zone ECU 104 and the slave ECUs 108 and 109, respectively.

The slave ECUs 110 and 111 receive the electric power from the battery 117 via the power supply paths 129 and 130 between the zone ECU 105 and the slave ECUs 110 and 111, respectively.

The slave ECUs 112, 113 and 114 receive the electric power from the battery 117 via the power supply paths 131, 132 and 133 between the zone ECU 106 and the slave ECUs 112, 113 and 114, respectively.

The slave ECUs 115 and 116 receive the electric power from the battery 117 via the power supply paths 134 and 135 between the zone ECU 107 and the slave ECUs 115 and 116, respectively.

The slave ECU 118 receives the electric power from the battery 117 via a power supply path 136. The central ECU 101 and the upstream power distribution unit 102 are connected to each other via a communication line 141 to exchange data with each other.

The central ECU 101 and the upstream power distribution unit 103 are connected to each other via a communication line 142 to exchange data with each other. The central ECU 101 and each of the zone ECUs 104, 105, 106, and 107 are connected to each other via corresponding communication line 143, 144, 145, and 146 to exchange data with each other.

The zone ECU 104 and the slave ECUs 108, 109 and 118 are connected to each other via a communication bus 147 to exchange data. The zone ECU 105 and the slave ECUs 110, 111 are connected to each other via a communication bus 148 to exchange data.

The zone ECU 106 and the slave ECUs 112, 113 and 114 are connected to each other via a communication bus 149 to exchange data. The zone ECU 107 and the slave ECUs 115, 116 are connected to each other via a communication bus 150 to exchange data.

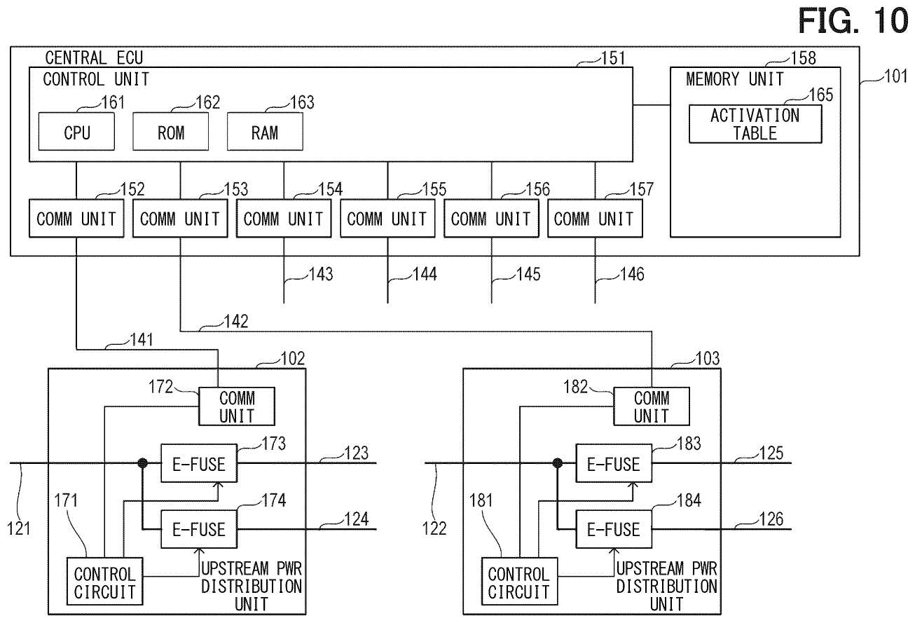

As shown in FIG. 10, the central ECU 101 includes a control unit 151, communication units 152, 153, 154, 155, 156, and 157, and a memory unit 158. The control unit 151 is an electronic control device mainly including a microcontroller with a CPU 161, a ROM 162, a RAM 163, and the like. Various functions of the microcontroller are implemented by the CPU 161 executing programs stored in a non-transitory tangible storage medium. In this example, the ROM 162 corresponds to the non-transitory tangible storage medium in which the programs are stored. A method corresponding to the program is executed by executing the program. Here, a part or all of the functions to be executed by the CPU 161 may be configured as hardware circuitry by one or multiple ICs or the like. Alternatively, the number of the microcontrollers constituting the control unit 151 may be one or more.

The communication unit 152 communicates with the upstream power distribution unit 102 connected to the communication line 141 by exchanging communication frames based on, for example, the Ethernet communication protocol. Ethernet is a registered trademark.

The communication unit 153 communicates with the upstream power distribution unit 103 connected to the communication line 142 by exchanging communication frames based on, for example, the Ethernet communication protocol. The communication unit 154 communicates with the zone ECU 104 connected to the communication line 143 by transmitting and receiving communication frames based on, for example, the Ethernet communication protocol.

The communication unit 155 communicates with the zone ECU 105 connected to the communication line 144 by transmitting and receiving communication frames based on, for example, the Ethernet communication protocol. The communication unit 156 communicates with the zone ECU 106 connected to the communication line 145 by transmitting and receiving communication frames based on, for example, the Ethernet communication protocol.

The communication unit 157 communicates with the zone ECU 107 connected to the communication line 145 by transmitting and receiving communication frames based on, for example, the Ethernet communication protocol. The memory unit 158 is a storage device for storing various data. The memory unit 158 stores an activation table 165 described later.

The upstream power distribution unit 102 includes a control circuit 171, a communication unit 172, and electronic fuses 173 and 174. The control circuit 171 performs control to switch the electronic fuses 173 and 174 between the on state and the off state based on an instruction acquired from the central ECU 101 via the communication unit 172.

The communication unit 172 communicates with the central ECU 101 connected to the communication line 141 by transmitting and receiving communication frames based on, for example, the Ethernet communication protocol.

The electronic fuse 173 is disposed between the power supply path 121 and the power supply path 123. The electronic fuse 174 is disposed between the power supply path 121 and the power supply path 124. The upstream power distribution unit 103 includes a control circuit 181, a communication unit 182, and electronic fuses 183 and 184.

The control circuit 181 performs control to switch the electronic fuses 183 and 184 between the on state and the off state based on an instruction acquired from the central ECU 101 via the communication unit 182.

The communication unit 182 communicates with the central ECU 101 connected to the communication line 142 by transmitting and receiving communication frames based on, for example, the Ethernet communication protocol.

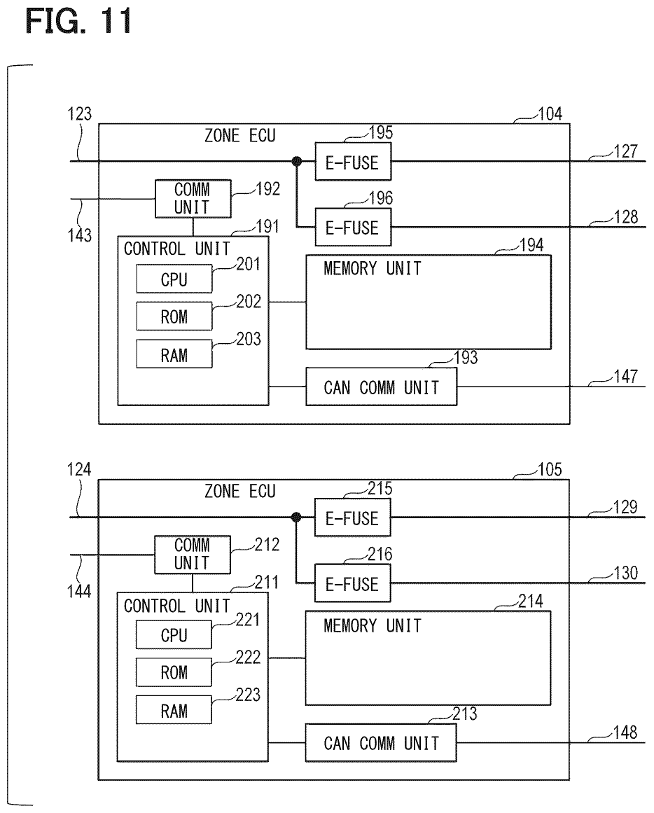

The electronic fuse 183 is disposed between the power supply path 122 and the power supply path 125. The electronic fuse 184 is disposed between the power supply path 122 and the power supply path 126. As shown in FIG. 11, the zone ECU 104 includes a control unit 191, a communication unit 192, a CAN communication unit 193, a memory unit 194, and electronic fuses 195 and 196.

The control unit 191 is an electronic control device mainly including a microcontroller with a CPU 201, a ROM 202, a RAM 203, and the like. Various functions of the microcontroller are implemented by the CPU 201 executing programs stored in a non-transitory tangible storage medium. In this example, the ROM 202 corresponds to the non-transitory tangible storage medium in which the programs are stored. A method corresponding to the program is executed by executing the program. Here, a part or all of the functions to be executed by the CPU 201 may be configured as hardware circuitry by one or multiple ICs or the like. Alternatively, the number of the microcontrollers constituting the control unit 191 may be one or more.

The communication unit 192 communicates with the central ECU 101 connected to the communication line 143 by transmitting and receiving communication frames based on, for example, the Ethernet communication protocol.

The CAN communication unit 193 communicates with the slave ECUs 108 and 109 connected to the communication bus 147 by transmitting and receiving communication frames based on the CAN communication protocol.

The memory unit 194 is a storage device for storing various data. The electronic fuse 195 is disposed between the power supply path 123 and the power supply path 127. The electronic fuse 196 is disposed between the power supply path 123 and the power supply path 128.

The zone ECU 105 includes a control unit 211, a communication unit 212, a CAN communication unit 213, a memory unit 214, and electronic fuses 215 and 216. The control unit 211 is an electronic control device mainly including a microcontroller with a CPU 221, a ROM 222, a RAM 223, and the like. Various functions of the microcontroller are implemented by the CPU 221 executing programs stored in a non-transitory tangible storage medium. In this example, the ROM 222 corresponds to the non-transitory tangible storage medium storing programs. A method corresponding to the program is executed by executing the program. Here, a part or all of the functions to be executed by the CPU 221 may be configured as hardware circuitry by one or multiple ICs or the like. Alternatively, the number of the microcontrollers constituting the control unit 211 may be one or more.

The communication unit 212 communicates with the central ECU 101 connected to the communication line 144 by transmitting and receiving communication frames based on, for example, the Ethernet communication protocol.

The CAN communication unit 213 communicates with the slave ECUs 110 and 111 connected to the communication bus 148 by transmitting and receiving communication frames based on the CAN communication protocol.

The memory unit 214 is a storage device for storing various data. The electronic fuse 215 is disposed between the power supply path 124 and the power supply path 129. The electronic fuse 216 is disposed between the power supply path 124 and the power supply path 130.

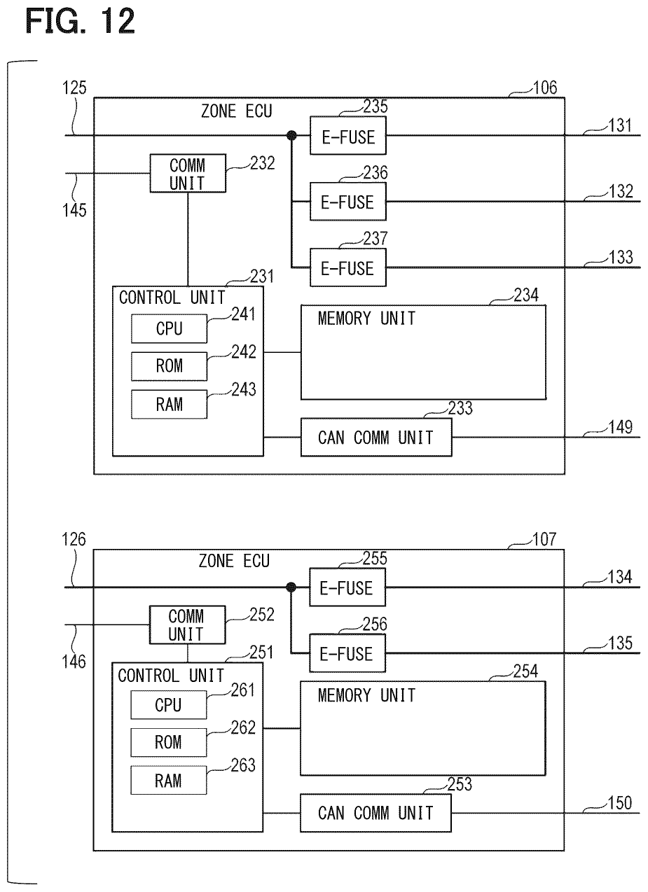

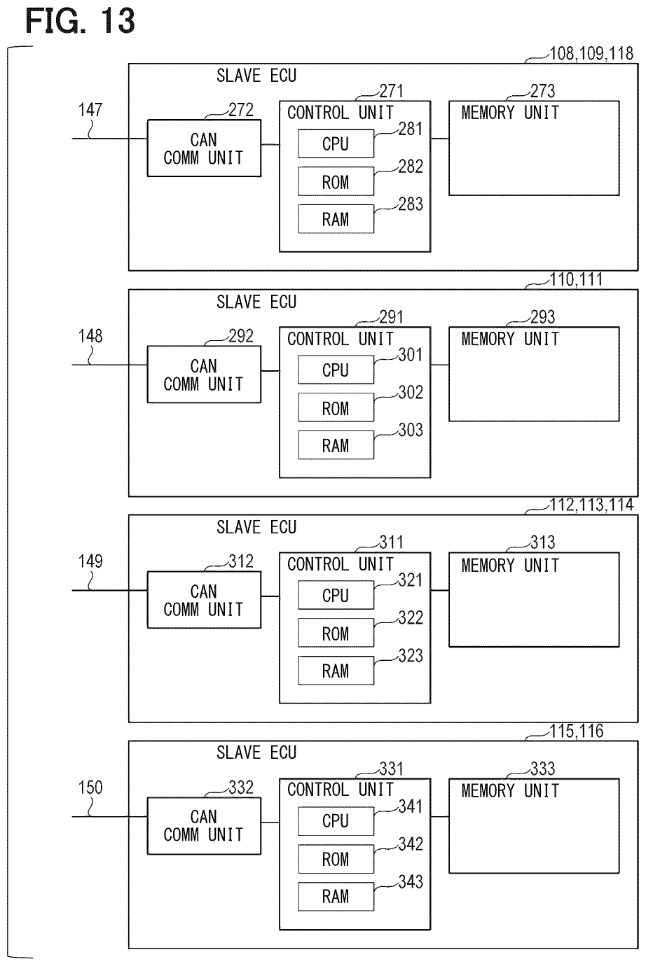

As shown in FIG. 12, the zone ECU 106 includes a control unit 231, a communication unit 232, a CAN communication unit 233, a memory unit 234, and electronic fuses 235, 236 and 237. The control unit 231 is an electronic control device mainly including a microcontroller with a CPU 241, a ROM 242, a RAM 243, and the like. Various functions of the microcontroller are implemented by the CPU 241 executing programs stored in a non-transitory tangible storage medium. In this example, the ROM 242 corresponds to the non-transitory tangible storage medium in which the programs are stored. A method corresponding to the program is executed by executing the program. Here, a part or all of the functions to be executed by the CPU 241 may be configured as hardware circuitry by one or multiple ICs or the like. Alternatively, the number of the microcontrollers constituting the control unit 231 may be one or more.

The communication unit 232 communicates with the central ECU 101 connected to the communication line 145 by transmitting and receiving communication frames based on, for example, the Ethernet communication protocol.

The CAN communication unit 233 communicates with the slave ECUs 112, 113 and 114 connected to the communication bus 149 by transmitting and receiving communication frames based on the CAN communication protocol.

The memory unit 234 is a storage device for storing various data. The electronic fuse 235 is disposed between the power supply path 125 and the power supply path 131. The electronic fuse 236 is disposed between the power supply path 125 and the power supply path 132. The electronic fuse 237 is disposed between the power supply path 125 and the power supply path 133.

The zone ECU 107 includes a control unit 251, a communication unit 252, a CAN communication unit 253, a memory unit 254, and electronic fuses 255 and 256. The control unit 251 is an electronic control device mainly including a microcontroller with a CPU 261, a ROM 262, a RAM 263, and the like. Various functions of the microcontroller are implemented by the CPU 261 executing programs stored in a non-transitory tangible storage medium. In this example, the ROM 262 corresponds to the non-transitory tangible storage medium in which the programs are stored. A method corresponding to the program is executed by executing the program. Here, a part or all of the functions to be executed by the CPU 261 may be configured as hardware circuitry by one or multiple ICs or the like. Alternatively, the number of the microcontrollers constituting the control unit 251 may be one or more.

The communication unit 252 communicates with the central ECU 101 connected to the communication line 146 by transmitting and receiving communication frames based on, for example, the Ethernet communication protocol.

The CAN communication unit 253 communicates with the slave ECUs 115 and 116 connected to the communication bus 150 by exchanging communication frames based on the CAN communication protocol.

The memory unit 254 is a storage device for storing various data. The electronic fuse 255 is disposed between the power supply path 126 and the power supply path 134. The electronic fuse 256 is disposed between the power supply path 126 and the power supply path 135.

As shown in FIG. 13, each of the slave ECUs 108, 109, and 118 includes a control unit 271, a CAN communication unit 272, and a memory unit 273. The control unit 271 is an electronic control device mainly including a microcontroller with a CPU 281, a ROM 282, a RAM 283, and the like. Various functions of the microcontroller are implemented by the CPU 281 executing programs stored in a non-transitory tangible storage medium. In this example, the ROM 282 corresponds to the non-transitory tangible storage medium in which the programs are stored. A method corresponding to the program is executed by executing the program. Here, a part or all of the functions to be executed by the CPU 281 may be configured as hardware circuitry by one or multiple ICs or the like. Alternatively, the number of the microcontrollers constituting the control unit 271 may be one or more.

The CAN communication unit 272 communicates with the zone ECU 104 connected to the communication bus 147 based on the CAN communication protocol. The memory unit 273 is a storage device for storing various data.

Each of the slave ECUs 110 and 111 includes a control unit 291, a CAN communication unit 292, and a memory unit 293. The control unit 291 is an electronic control device mainly including a microcontroller with a CPU 301, a ROM 302, a RAM 303, and the like. Various functions of the microcontroller are implemented by the CPU 301 executing programs stored in a non-transitory tangible storage medium. In this example, the ROM 302 corresponds to the non-transitory tangible storage medium in which the programs are stored. A method corresponding to the program is executed by executing the program. Here, a part or all of the functions to be executed by the CPU 301 may be configured as hardware circuitry by one or multiple ICs or the like. Alternatively, the number of the microcontrollers constituting the control unit 291 may be one or more.

The CAN communication unit 292 communicates with the zone ECU 105 connected to the communication bus 148 based on the CAN communication protocol. The memory unit 293 is a storage device for storing various data.

Each of the slave ECUs 112, 113 and 114 includes the control unit 311, the CAN communication unit 312, and the memory unit 313. The control unit 311 is an electronic control device mainly including a microcontroller with a CPU 321, a ROM 322, a RAM 323, and the like. Various functions of the microcontroller are implemented by the CPU 321 executing programs stored in a non-transitory tangible storage medium. In this example, the ROM 322 corresponds to the non-transitory tangible storage medium in which the programs are stored. A method corresponding to the program is executed by executing the program. Here, a part or all of the functions to be executed by the CPU 321 may be configured as hardware circuitry by one or multiple ICs or the like. Alternatively, the number of the microcontrollers constituting the control unit 311 may be one or more.

The CAN communication unit 312 communicates with the zone ECU 106 connected to the communication bus 149 based on the CAN communication protocol. The memory unit 313 is a storage device for storing various data.

Each of the slave ECUs 115 and 116 includes the control unit 331, the CAN communication unit 332, and the memory unit 333. The control unit 331 is an electronic control device mainly including a microcontroller with a CPU 341, a ROM 342, a RAM 343, and the like. Various functions of the microcontroller are implemented by the CPU 341 executing programs stored in a non-transitory tangible storage medium. In this example, the ROM 342 corresponds to the non-transitory tangible storage medium in which the programs are stored. A method corresponding to the program is executed by executing the program. Here, a part or all of the functions to be executed by the CPU 341 may be configured as hardware circuitry by one or multiple ICs or the like. Alternatively, the number of the microcontrollers constituting the control unit 331 may be one or more.

The CAN communication unit 332 communicates with the zone ECU 107 connected to the communication bus 150 based on the CAN communication protocol. The memory unit 333 is a storage device for storing various data.

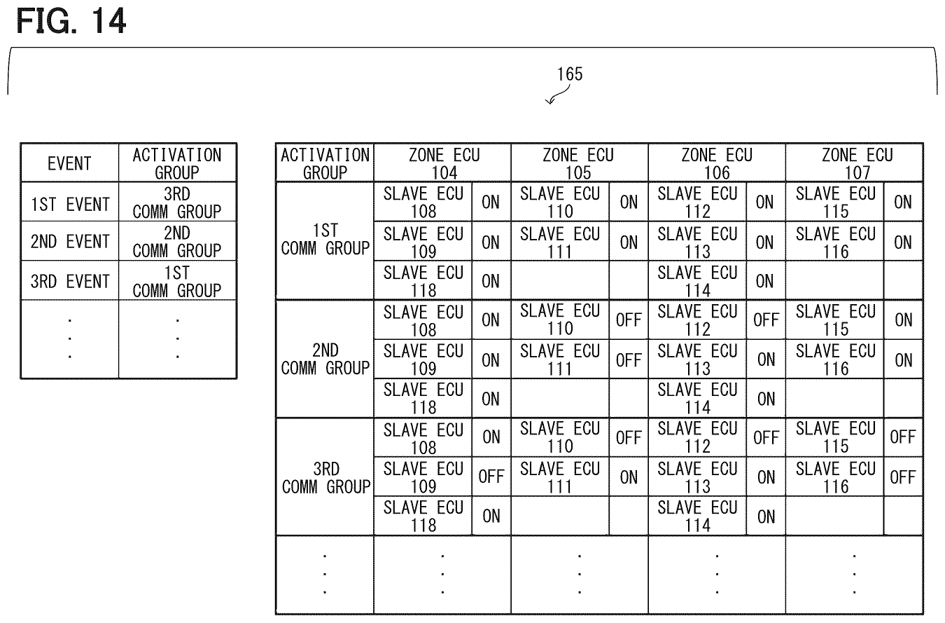

As shown in FIG. 14, in the activation table 165 of the central ECU 101, a communication group to be activated (i.e., an activation group) is set for each event. The activation table 165 further includes a correspondence between the activation group and at least one slave ECU to be set into a wake-up mode. The activation table 165 further includes a correspondence between the slave ECU and the electronic fuse connected to the slave ECU. The activation table 165 may be set in such a way that it is possible to recognize the correspondence relationship between the zone ECU and the slaves ECU in control of the zone ECU.

When the central ECU 101 detects the occurrence of an event, the central ECU 101 determines the activation group by referring to the activation table 165 based on the detected event. When the central ECU 101 receives an NM frame, the central ECU 101 determines that the communication group corresponding to the bit set to 1 in the received NM frame is the activation group.

The central ECU 101 starts a process of transmitting an NM frame, which indicates the activation group determined upon detection of the event or reception of an NM frame, to the zone ECUs 104, 105, 106, and 107. After starting the transmission of the NM frame, the central ECU 101 periodically transmits the same NM frames.

The central ECU 101 refers the activation table 165 and transmits electronic fuse control instructions to the upstream power distribution unit 102 and 103 and the zone ECUs 104, 105, 106, and 107. The electronic fuse control instructions include an instruction to turn on the electronic fuses corresponding to the activation group determined based on the event or the received NM frame and an instruction to turn off the electronic fuses other than the electronic fuses corresponding to the activation group.

The upstream electric power distribution unit 102 switches the electronic fuses 173 and 174 between the on state and the off state based on the received electronic fuse control instruction. The upstream electric power distribution unit 103 switches the electronic fuses 183 and 184 between the on state and the off state based on the received electronic fuse control instruction.

The zone ECU 104 switches the electronic fuses 195 and 196 between the on state and the off state based on the received electronic fuse control instruction. The zone ECU 105 switches the electronic fuses 215 and 216 between the on state and the off state based on the received electronic fuse control instruction.

The zone ECU 106 switches the electronic fuses 235, 236 and 237 between the on state and the off state based on the received electronic fuse control instruction. The zone ECU 107 switches the electronic fuses 255 and 256 between the on state and the off state based on the received electronic fuse control instruction.

Next, the procedure of state transition processing executed by the slave ECUs 108 to 116. The state transition processing is repeatedly executed during the slave ECUs 108 to 116 operating. In the following, the procedure of the state transition processing will be described using the slave ECU 108 as a representative example.

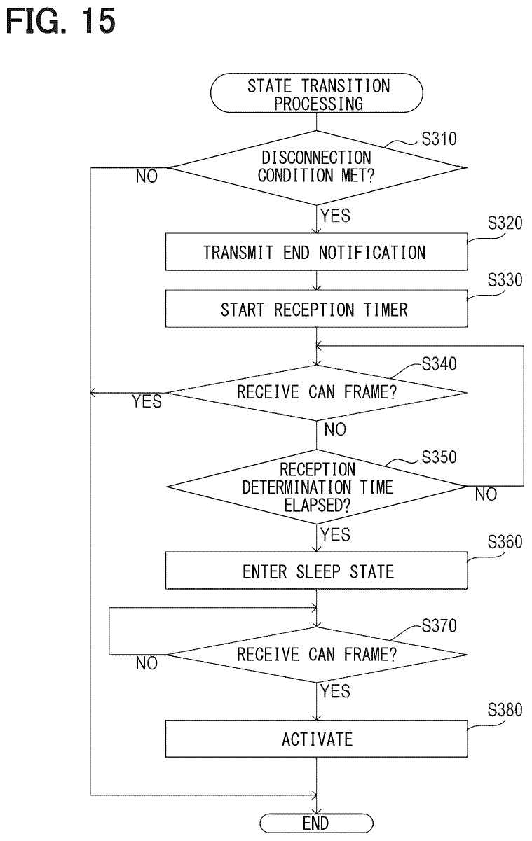

When the state transition processing is executed, as shown in FIG. 15, the CPU 281 of the control unit 271 of the slave ECU 108 determines whether a predetermined disconnection condition is met in S310, in the same manner as in S10.

Here, when the disconnection condition is not met, the CPU 281 ends the state transition processing. On the other hand, when the disconnection condition is met, the CPU 281 transmits, in S320, to the central ECU 101 an end notification indicating that the electronic fuse connected to the own node is allowed to switch to the disconnected state. Specifically, the CPU 281 transmits the end notification to the zone ECU 104. The zone ECU 104 transfers the end notification received from the CPU 281 of the slave ECU 108 to the central ECU 101.

When a waiting period predetermined for the slave ECU 108 has elapsed since the central ECU 101 received the end notification from the slave ECU 108, the central ECU 101 transmits electronic fuse control instruction, which requests turning off the electronic fuse 195, to the zone ECU 104 and switch the electronic fuse 195 to the disconnected state.

The CPU 281 starts a reception timer provided in the RAM 283 in S330, in the same manner as in S30. In S340, the CPU 281 determines whether a CAN frame addressed to the own node has been received, in the same manner as in S40. If the CPU 281 has received a CAN frame addressed to the own node, the CPU 281 ends the state transition processing. On the other hand, if the CPU 281 has not received a CAN frame addressed to the own node, the CPU 281 determines in S350 whether a predetermined reception determination period has elapsed, in the same manner as in S50.

When the reception determination period has not elapsed, the CPU 281 moves the processing to S340. On the other hand, when the reception determination period has elapsed, the CPU 281 in S360 executes various end processes before entering the sleep mode in the same manner as in S60, and shifts the own node to the sleep mode after the various end processes has been completed.

In S370, the CPU 281 determines whether a CAN frame has been received, in the same manner as in S70. Here, when a CAN frame has not been received, the CPU 281 repeats the processing of S370 and waits until the CAN frame is received. Then, when the CAN frame is received, the CPU 281 activates the own node in S380 in the same manner as in S80, and ends the state transition processing.

The slave ECUs 108 to 116 described above are configured to receive electric power from the battery 117 via the electric fuses 195, 196, 215, 216, 235, 236, 237, 255, and 256 each of which is configured to selectively switch between the connected state in which the power supply path is electrically connected to the battery 117 and the disconnected state in which the power supply path is electrically disconnected from the battery 117.

The slave ECUs 108 to 116 are configured to transmit an end notification to the central ECU 101 when a predetermined disconnection condition, which indicates that the electronic fuses 195, 196, 215, 216, 235, 237, 255, and 256 connected to the slave ECUs 108 to 116 are allowed to switch to the disconnected state is met. The central ECU 101 is connected to the slave ECUs 108 to 116 for data communication, and configured to exchange CAN frames with the slave ECUs 108 to 116. The central ECU 101 is configured to control operations of the electronic fuses 195, 196, 215, 216, 235, 236, 237, 255, and 256.

The slave ECUs 108 to 116 are configured to enter the sleep mode if the predetermined reception determination period has elapsed since the disconnection condition was met and if the slave ECUs 108 to 116 do not receive a CAN frame addressed to the own node from all of the multiple communication devices (i.e., the central ECU 101, the zone ECUs 104 to 107, and the slave ECUs 108 to 116, 118) that are connected to the slave ECUs 108 to 116 for data communication during the reception determination period.

Such slave ECUs 108 to 116 can enter the sleep mode even if a malfunction occurs in which the central ECU 101, which has received an end notification from the slave ECUs 108 to 116 and tries to switch the electronic fuses 195, 196, 215, 216, 235, 236, 237, 255, and 256 to the disconnected state, fails to switch the electronic fuses 195, 196, 215, 216, 235, 236, 237, 255, and 256 to the disconnected state. As a result, the slave 108 to 116 can avoid staying in the wake-up mode with the electronic fuses 195, 196, 215, 216, 235, 236, 237, 255, and 256 in the connected state even through the slave ECUs 108 to 116 are allowed to stop operating by setting the electronic fuses 195, 196, 215, 216, 235, 236, 237, 255, and 256 to the disconnected state. Thus, the slave ECUs 108 to 116 can avoid wasting electric power, thereby reducing the power consumption in the communication system 100.

In the embodiment described above, each of the electronic fuses 195, 196, 215, 216, 235, 236, 237, 255, and 256 corresponds to a power switch, the battery 117 corresponds to a power source, each of the slave ECUs 108 to 116 corresponds to an electronic controller or a first controller, the central ECU 101 corresponds to a power supply controller or a second controller.

Moreover, processing of S310 and S320 corresponds to processing performed by the end notification unit, processing from S330 through S360 corresponds to processing performed by the sleep transition unit, and processing from S370 and S380 corresponds to processing performed by the wake-up transition unit.

Moreover, each of the slave ECUs 108 to 116 corresponds to the slave control device, each of the zone ECUs 104 to 107 corresponds to the zone control device, and the central ECU 101 corresponds to the central control device.

(Sixth Embodiment) The following describes a sixth embodiment of the present disclosure with reference to the drawings. In the sixth embodiment, portions different from the fifth embodiment will be described. Common configurations are denoted by the same reference numerals.

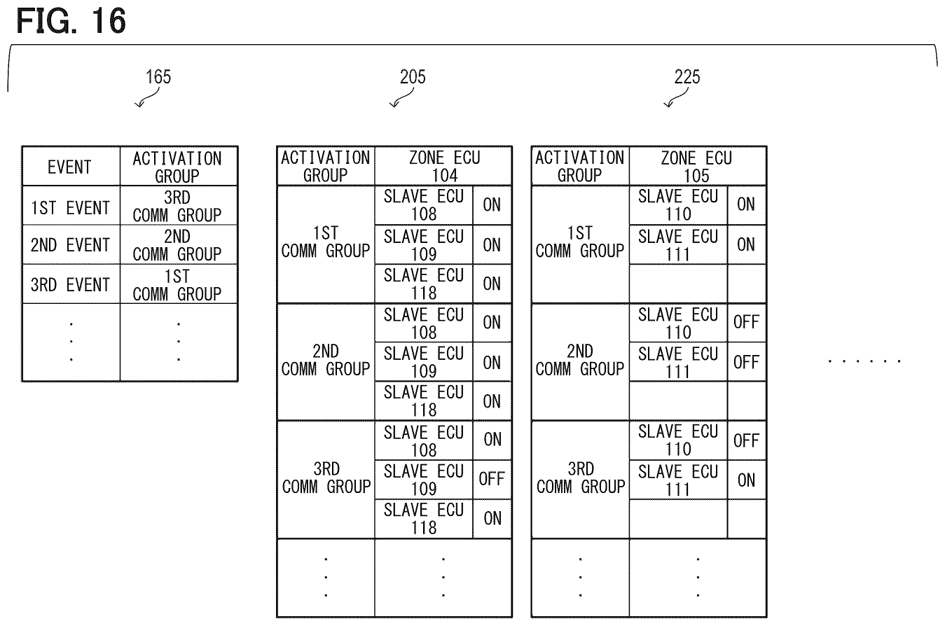

As shown in FIG. 16, the communication system 100 of the sixth embodiment is different from the fifth embodiment in that the configuration of the activation table 165 included in the central ECU 101 is changed. That is, in the activation table 165 of the sixth embodiment, an activation group is set for each event. In other words, the activation table 165 of the sixth embodiment does not have a corresponding relationship between an activation group and a slave ECU to be put into a wake-up mode.

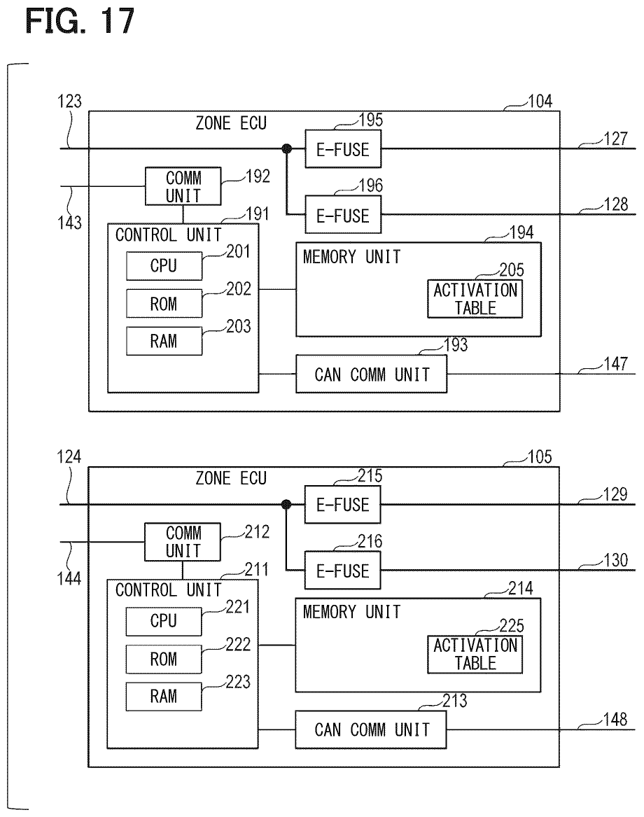

As shown in FIG. 17, the sixth embodiment differs from the fifth embodiment in that the memory unit 194 of the zone ECU 104 further stores an activation table 205, which will be described later. The sixth embodiment differs from the fifth embodiment in that the memory unit 214 of the zone ECU 105 further stores an activation table 225, which will be described later.

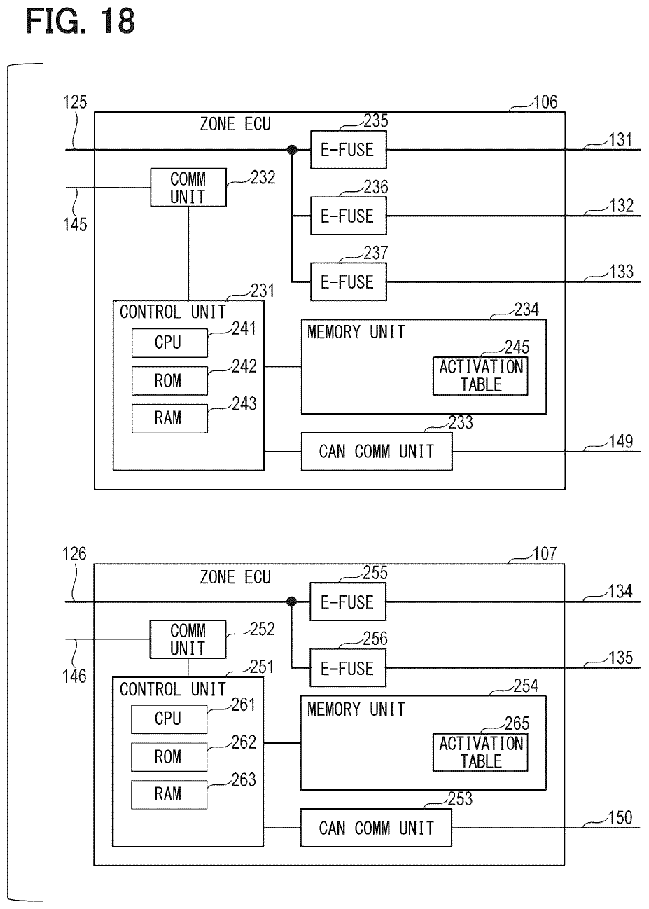

As shown in FIG. 18, the sixth embodiment differs from the fifth embodiment in that the memory unit 234 of the zone ECU 106 further stores an activation table 245, which will be described later. The sixth embodiment differs from the fifth embodiment in that the memory unit 254 of the zone ECU 107 further stores an activation table 265, which will be described later.

As shown in FIG. 16, the activation table 205 sets a correspondence relationship between an activation group and slave ECUs to be put into a wake-up mode, for the slave ECUs 108, 109, and 118 in control of the zone ECU 104. The activation table 205 further includes a correspondence relationship between the slave ECUs 108, 109 and 118 and the electronic fuses connected to the slave ECUs 108, 109 and 118.

In the activation table 225, for the slave ECUs 110 and 111 in control of the zone ECU 105, a correspondence relationship is set between an activation group and a slave ECU to be put into a wake-up mode. The activation table 225 further includes a correspondence relationship between the slave ECUs 110 and 111 and the electronic fuses connected to the slave ECUs 110 and 111.

In the activation table 245, for the slave ECUs 112, 113 and 114 in control of the zone ECU 106, a correspondence relationship between an activation group and slave ECUs to be put into a wake-up mode is set. The activation table 225 further includes a correspondence relationship between the slave ECUs 112, 113 and 114 and the electronic fuses connected to the slave ECUs 112, 113 and 114.

In the activation table 265, for the slave ECUs 115 and 116 in control of the zone ECU 107, a correspondence relationship is set between an activation group and the slave ECUs to be put into a wake-up mode. The activation table 265 further includes a correspondence relationship between the slave ECUs 115 and 116 and the electronic fuses connected to the slave ECUs 115 and 116.

When the central ECU 101 detects the occurrence of an event, the central ECU 101 determines the activation group by referring to the activation table 165 based on the detected event. When the central ECU 101 receives an NM frame, the central ECU 101 determines that the communication group corresponding to the bit set to 1 in the received NM frame is the activation group.

The central ECU 101 starts a process of transmitting an NM frame, which indicates the activation group determined upon detection of the event or reception of an NM frame, to the zone ECUs 104, 105, 106, and 107. After starting the transmission of the NM frame, the central ECU 101 periodically transmits the same NM frames.

If the zone ECUs 104, 105, 106, and 107 receive an NM frame, the zone ECUs 104, 105, 106, and 107 transfer the received NM frame to the slave ECUs in control of the zone ECUs 104, 105, 106, and 107. Also, the zone ECUs 104, 105, 106, and 107 refer the activation tables 205, 225, 245, and 265 based on the received NM frame, and turn on the electronic fuses corresponding to the activation group indicated by the NM frame and turn off the electronic fuses other than the electronic fuses corresponding to the activation group for the slave ECUs in control.

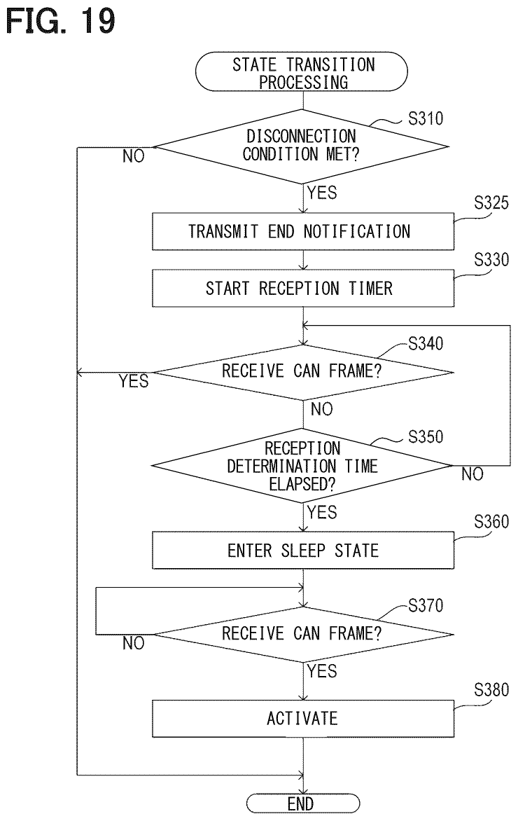

Next, the procedure of the state transition processing according to the sixth embodiment will be described. As shown in FIG. 19, the state transition processing of the sixth embodiment differs from that of the fifth embodiment in that the process of S325 is executed instead of S320.

That is, when the disconnection condition is met in S310, the CPU 281 transmits, in S325, to the zone ECU 104 an end notification indicating that the electronic fuse connected to the own node is allowed to switch to the disconnected state, and then moves the processing to S330.

When the zone ECU 104 receives the end notification from the slave ECU 108, the zone ECU 104 turns off the electronic fuse 195 after a waiting period predetermined for the slave ECU 108 has elapsed, for example.

The slave ECUs 108 and 109 described above are configured to receive electric power from the battery 117 via the electronic fuses 195 and 196 that are configured to switch between the connected state in which the power supply path is electrically connected to the battery 117 and the disconnected state in which the power supply path is electrically disconnected from the battery 117.

The slave ECUs 108 and 109 are configured to transmit an end notification to the zone ECU 104 when a predetermined disconnection condition is met, which indicates that the electronic fuses 195 and 196 connected to the slave ECUs 108 and 106 are allowed to switch to the disconnected state. The central ECU 101 and the zone ECU 104 are connected to the slave ECUs 108 and 109 for data communication and configured to exchange communication frames with the slave ECUs 108 and 109. The central ECU 101 and the zone ECU 104 are configured to control operations of the electronic fuses 105 and 196.

The slave ECUs 108 and 109 are configured to enter the sleep mode if the predetermined reception determination period has elapsed since the disconnection condition was met and if the slave ECUs 108 and 109 do not receive a CAN frame addressed to the own node during the predetermined reception determination period from all of the multiple communication devices (i.e., the central ECU 101, the zone ECUs 104 to 107, and the slave ECUs 108 to 116, 118) that are connected to the slave ECUs 108 and 109 for data communication.

Such slave ECUs 108 and 109 can enter the sleep mode even if a malfunction occurs in which the zone ECU 104, which has received an end notification from the slave ECUs 108 and 109 and tries to switch the electronic fuses 195 and 196 to the disconnected state, fails to switch the electronic fuses 195 and 196 to the disconnected state. As a result, the slave ECUs 108 and 109 can avoid staying in the wake-up mode with the electronic fuses 195 and 196 in the connected state even through the slave ECUs 108 and 109 are allowed to stop operating by setting the electronic fuses 195 and 196 to the disconnected state. Thus, the slave ECUs 108 and 109 can avoid wasting electric power, thereby reducing the power consumption in the communication system 100.

The slave ECUs 110 and 111 are configured to transmit an end notification to the zone ECU 105 when a predetermined disconnection condition is met, which indicates that the electronic fuses 215 and 216 connected to the slave ECUs 110 and 111 are allowed to switch to the disconnected state.

The slave ECUs 112, 113, and 114 are configured to transmit an end notification to the zone ECU 106 when a predetermined disconnection condition is met, which indicates that the electronic fuses 235, 236, and 237 connected to the slave ECUs 112, 113, and 114 are allowed to switch to the disconnected state.

The slave ECUs 115 and 116 are configured to transmit an end notification to the zone ECU 107 when a predetermined disconnection condition is met, which indicates that the electronic fuses 255 and 256 connected to the slave ECUs 115 and 116 are allowed to switch to the disconnected state.

In the embodiment described above, each of the slave ECUs 108 to 116 corresponds to the electronic controller or the first controller, each of the central ECU 101 and the zone ECUs 104 to 107 corresponds to the power supply controller or the second controller, and processing of S310 and S325 corresponds to the processing performed by the end notification unit.

(Seventh Embodiment) The following describes a seventh embodiment of the present disclosure with reference to the drawings. In the seventh embodiment, portions different from those of the fifth embodiment will be described. Common configurations are denoted by the same reference numerals.

The communication system 100 of the seventh embodiment differs from the fifth embodiment in state transition processing and in that the central ECU 101 executes the state transmission processing. Next, the procedure of the state transmission processing executed by the control unit 151 of the central ECU 101 will be described. The state transmission processing is repeatedly executed while the central ECU 101 is operating.

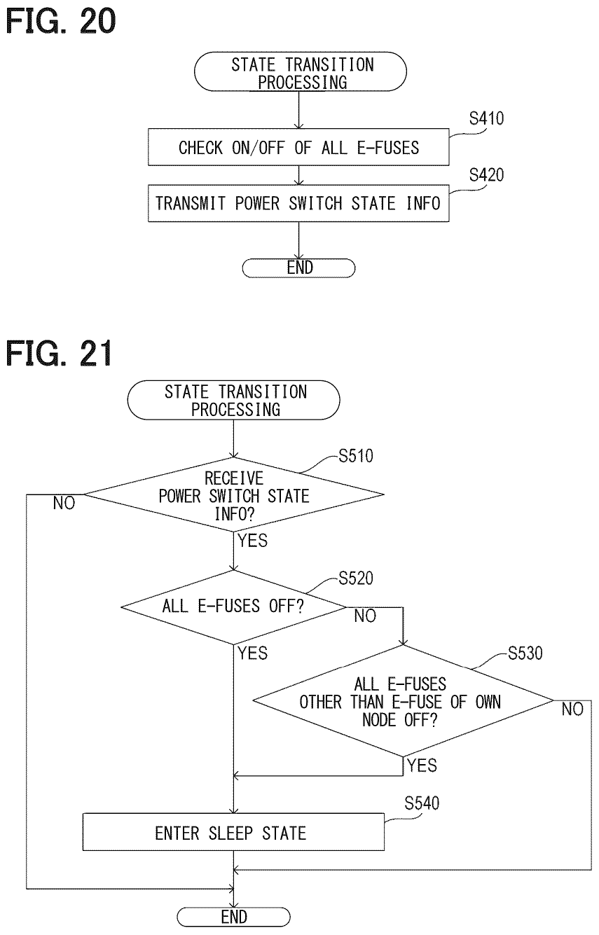

When the state transmission processing is executed, the CPU 161 of the control unit 151 checks in S410 whether each of the electronic fuses 195, 196, 215, 216, 235, 236, 237, 255, and 256 is in the on state or the off state, as shown in FIG. 20.

Specifically, the zone ECU 104 first detects the value of current flowing through the power supply path in which each of the electronic fuses 195 and 196 in control is arranged (hereinafter, referred to as a fuse current value). When the detected fuse current value is equal to or greater than a predetermined on-determination value, the zone ECU 104 determines that the corresponding electronic fuse is in the on-state, and when the detected fuse current value is less than the on-determination value, the zone ECU 104 determines that the corresponding fuse is in the off-state. The zone ECU 104 then transmits to the central ECU 101 electronic fuse state information indicating each of the electronic fuses 195 and 196 in control is in the on state or the off state.

Similar to the zone ECU 104, the zone ECUs 105, 106, and 107 detect the fuse current value of the electronic fuses in control and transmit, to the central ECU 101, electronic fuse state information indicating whether the fuses are in the on state or the off state.

The central ECU 101 determines whether each of the electronic fuses 195, 196, 215, 216, 235, 236, 237, 255, and 256 is in the on state or the off state based on the electronic fuse state information received from each of the zone ECUs 104, 105, 106, and 107.

In S420, the CPU 161 transmits, to the slave ECUs 108 to 116, switch state information indicating that each of the electronic fuses 195, 196, 215, 216, 235, 236, 237, 255, and 256 is in the on state or the off state based on the check results in S410, and then ends the state transmission processing.

Next, the procedure of the state transition processing according to the seventh embodiment will be described. In the following, the procedure of the state transition processing will be described using the slave ECU 108 as a representative example. When the state transition processing is executed, the CPU 281 of the control unit 271 of the slave ECU 108 determines in S510 whether the switch state information is received from the central ECU 101 as shown in FIG. 21.

When no switch state information has been received, the CPU 281 ends the state transition processing. On the other hand, when having received the switch state information, the CPU 281 determines in S520 whether all the electronic fuses (i.e., the electronic fuses 195, 196, 215, 216, 235, 236, 237, 255, and 256) are in the off state based on the received switch state information. When all the electronic fuses are in the off state, the CPU 281 shifts the processing to S540.

On the other hand, if at least one of the electronic fuses is in the on state, the CPU 281 determines in S530 whether all the electronic fuses other than the electronic fuse of the own node are in the off state.

If there is an electronic fuse in the on state except the electronic fuse of the own node, the CPU 281 ends the state transition processing. On the other hand, if all the electronic fuses except the electronic fuse of the own node are in the off state, the CPU 281 shifts the processing to S540.

In S540, the CPU 281 shifts the own node to the sleep mode, and ends the state transition processing. The slave ECUs 108 to 116 described above are configured to receive electric power from the battery 117 via the electric fuses 195, 196, 215, 216, 235, 236, 237, 255, and 256 each of which is configured to selectively switch between the connected state in which the power supply path is electrically connected to the battery 117 and the disconnected state in which the power supply path is electrically disconnected from the battery 117.

Each of the slave ECUs 108 to 116 is configured to enter the sleep mode when the switch state information received from the central ECU 101 indicates that all of the electronic fuses 195, 196, 215, 216, 235, 236, 237, 255, and 256 are in the off state or that all of the electronic fuses except for the electronic fuse 195, 196, 215, 216, 235, 236, 237, 255, and 256 connected to the slave ECU 108 to 116 are in the off state. The central ECU 101 is connected to the slave ECUs 108 to 116 for data communication and configured to control operations of the electronic fuses 195, 196, 215, 216, 235, 236, 237, 255, and 256 connected to the slave ECUs 108 to 116. The switch state information indicates each of the electronic fuses 195, 196, 215, 216, 235, 236, 237, 255, and 256 connected to the slave ECUs 108 to 116 is in the connected state or the disconnected state.

Such slave ECUs 108 to 116 can avoid keeping operating even in an abnormal situation where all of the electronic fuses 195, 196, 215, 216, 235, 236, 237, 255, and 256 connected to the slave ECUs 108 to 116 are in the disconnected state or all of the electric fuses except for the electronic fuse connected to the slave ECU 108 to 116 are in the disconnected state. Thus, the slave ECUs 108 to 116 can avoid wasting electric power, which reduces the power consumption in the communication system 100. A state in which all of the electronic fuses 195, 196, 215, 216, 235, 236, 237, 255, and 256 are in the disconnected state, and a state in which only one of the electronic fuses 195, 196, 215, 216, 235, 236, 237, 255, and 256 is in the connected state indicate a malfunction.

In the embodiment described above, the electronic fuses correspond to power switches, the processing of S420 corresponds to the processing executed by the state information transmitting unit, and the processing from S520 through S540 corresponds to the processing executed by the disconnection transition unit.

One embodiment of the present disclosure has been described above, but the present disclosure is not limited to the above embodiments and can be implemented in various modified forms.

(First Modified Example) In the above first to third embodiments, the power supply is controlled with relays 15 to 17, but electronic fuses may be used instead of the relays 15 to 17.

(Second Modified Example) In the above first embodiment, the slave ECU enters the sleep mode when the reception determination period has elapsed without receiving a CAN frame addressed to the own node. However, the slave ECU may enter the sleep mode when a CAN frame is not received regardless of whether the CAN frame is addressed to the own node or not.

(Third Modified Example) In the above first embodiment, the own node enters the wake-up mode when not only a CAN frame addressed to the own node but also a CAN frame addressed to another node is received. However, the node may enter the sleep wake-up mode only when a CAN frame addressed to the own node is received. Thereby, the communication system 1 can reduce the frequency at which the own node enters the wake-up mode when the own node need not execute processing, which further reduces the power consumption in the communication system.

(Fourth Modified Example) In the above second embodiment, the own node enters the sleep mode in the processing of S240. However, the own node may enter a stop mode in the processing of S240. The stop mode is an operating state in which even functions that operate in the sleep mode are stopped.

(Fifth Modified Example) In the above first embodiment, an end notification is sent in S20 immediately after the disconnection condition is met in S10. However, the end notification may be sent immediately before the process of S60.

(Sixth Modified Example) In the above fifth embodiment, the slave ECUs 108 to 116 execute the state transition processing. However, the zone ECUs 104 to 107 may execute the state transition processing. For example, when the disconnection condition is met, the zone ECU 104 transmits to the central ECU 101 an end notification indicating that the electronic fuse 173 connected to the own node is allowed to switch to the disconnected state. If the zone ECU 104 does not receive a communication frame addressed to the own node before the reception determination period has elapsed, the zone ECU 104 shifts the own node to the sleep mode. In this case, each of the zone ECUs 104 to 107 corresponds to a first controller, each of the electronic fuses 173, 174, 183, and 184 corresponds to a power switch, and the central ECU 101 corresponds to a second controller.

The control units 11 and 31 and methods thereof described in the present disclosure may be implemented by a dedicated computer including a processor and a memory programmed to perform one or more functions embodied by a computer program. Alternatively, the control units 11 and 31 and the method thereof described in the present disclosure may be implemented by a dedicated computer including a processor implemented by one or more dedicated hardware logic circuits. Alternatively, the control units 11 and 31 and the methods thereof described in the present disclosure may be implemented by one or more dedicated computers implemented by a combination of a processor and a memory programmed to execute one or more functions, and a processor implemented by one or more hardware logic circuits. The computer program may be stored in a computer-readable non-transitory tangible storage medium as instructions to be executed by a computer. The methods of implementing the function of each part included in the control units 11 and 31 do not necessarily include software, and all the functions may be implemented using one or more pieces of hardware.

The multiple functions of one component in the above embodiment may be realized by multiple components, or a function of one component may be realized by the multiple components. In addition, multiple functions of multiple components may be realized by one component, or a single function realized by multiple components may be realized by one component. Moreover, a part of the configuration of the above-described embodiment may be omitted. At least a part of the configuration of the above embodiment may be added to or replaced with a configuration of another embodiment.

In addition to the ECUs 2 to 5, 101, and 104-116 described above, various features such as a system including the ECUs 2 to 5, 101, and 104-116 as a component, a program for causing a computer to function as the ECUs 2 to 5, 101, and 104-116, a non-transitory tangible storage medium such as a semiconductor memory in which this program is stored, and a communication method can also provide the present embodiments.

1. An electronic controller configured to receive electric power from a power source through a power switch, the power switch being controlled, by a power supply controller, to selectively switch between a connected state in which a power supply path is electrically connected to the power source and a disconnected state in which the power supply path is electrically disconnected from the power source, the electronic controller being communicatively connected to one or more of communication devices including the power supply controller, the electronic controller comprising:
an end notification unit configured to transmit an end notification to the power supply controller that is configured to exchange a communication frame with the electronic controller when a predetermined disconnection condition is met, wherein the predetermined disconnection condition indicates the power switch connected to the electronic controller is allowed to switch to the disconnected state; and
a sleep transition unit configured to put the electronic controller into a sleep mode when the sleep transition unit does not receive the communication frame from any one of the one or more of communication devices for a predetermined reception determination period after the disconnection condition was met.

2. The electronic controller according to claim 1, further comprising a wake-up transition unit configured to put the electronic controller into a wake-up mode when the electronic controller in the sleep mode receives the communication frame from at least one of the one or more of communication devices.

3. The electronic controller according to claim 1, wherein the sleep transition unit is further configured to put the electronic controller into the sleep mode when the sleep transition unit does not receive the communication frame addressed to the electronic controller.

4. The electronic controller according to claim 2, wherein the wake-up transition unit is further configured to put the electronic controller into the wake-up mode when the wake-up transition unit receives the communication frame addressed to the electronic controller.

5. The electronic controller according to claim 1, wherein the disconnection condition includes a low voltage condition indicating that a voltage of the power source is less than a predetermined disconnection determination value.

6. The electronic controller according to claim 1, wherein the disconnection condition includes a power supply malfunction condition indicating that a malfunction exists in a power supply process from the power source to the electronic controller.

7. An electronic controller configured to receive electric power from a power source through at least one of power switches, each of the power switches being controlled, by a power supply controller, to selectively switch between a connected state in which a power supply path is electrically connected to the power source and a disconnected state in which the power supply path is electrically disconnected from the power source, the electronic controller being communicatively connected to the power supply controller, the electronic controller comprising:
a disconnection transition unit configured to put the electronic controller into a stop mode or a sleep mode based on switch state information received from the power supply controller, the switch state information indicating each of the power switches is in the connected state or the disconnected state, wherein the disconnection transition unit puts the electronic controller into the stop mode or the sleep mode when the switch state information indicates all the power switches are in the disconnected state or all the power switches except the at least one of the power switches connected to the electronic controller are in the disconnected state.

8. A communication system comprising:
a first controller that is configured to receive electric power from a power source through a power switch, the first controller being communicatively connected to one or more of communication devices;
a second controller that is one of the one or more of communication devices and configured to exchange a communication frame with the first controller, the second controller being configured to control the power switch to selectively switch between a connected state in which a power supply path is electrically connected to the power source and a disconnected state in which the power supply path is electrically disconnected from the power source, wherein
the first controller includes:
an end notification unit configured to transmit an end notification to the second controller when a predetermined disconnection condition is met, wherein the predetermined disconnection condition indicates the power switch connected to the first controller is allowed to switch to the disconnected state; and
a sleep transition unit configured to put the first controller into a sleep mode when the sleep transition unit does not receive the communication frame from any one of the one or more of communication devices for a predetermined reception determination period after the disconnection condition was met.

9. A communication system comprising:
power switches each of which is controlled to selectively switch between a connected state in which a power supply path is electrically connected to a power source and a disconnected state in which the power supply path is electrically disconnected from the power source;
a first controller configured to receive electric power from the power source through at least one of the power switches;
a second controller communicatively connected to the first controller and configured to control the power switches, wherein the second controller includes
a state information transmitting unit configured to transmit switch state information to the first controller, the switch state information indicating each of the power switches is in the connected state or the disconnected state, and
the first controller includes
a disconnection transition unit configured to put the first controller into a stop mode or a sleep mode when the switch state information received from the second controller indicates all the power switches are in the disconnected state or all the power switches except the at least one of the power switches connected to the first controller are in the disconnected state.

10. The communication system according to claim 8, comprising:
a slave control device as the first controller;
a zone control device communicatively connected to the slave control device and including the power switch; and
a central control device communicatively connected to the zone control device and configured to control the power switch as the second controller, wherein
the slave control device and the central control device are communicatively connected to each other through the zone control device.

11. The communication system according to claim 9, comprising:
a slave control device as the first controller;
a zone control device communicatively connected to the slave control device and including the at least one of the power switches; and
a central control device communicatively connected to the zone control device and configured to control the at least one of the power switches as the second controller, wherein
the slave control device and the central control device are communicatively connected to each other through the zone control device.

12. The communication system according to claim 8, comprising:
a slave control device as the first controller; and
a zone control device and a central control device as the second controller, wherein
the zone control device is communicatively connected to the slave control device, includes the power switch, and is configured to control the power switch,
the central control device is communicatively connected to the zone control device, and
the slave control device and the central control device are communicatively connected to each other through the zone control device.

13. The communication system according to claim 9, comprising:
a slave control device as the first controller; and
a zone control device and a central control device as the second controller, wherein
the zone control device is communicatively connected to the slave control device, includes the at least one of the power switches, and is configured to control the at least one of the power switches,
the central control device is communicatively connected to the zone control device, and
the slave control device and the central control device are communicatively connected to each other through the zone control device.

14. The communication system according to claim 8, further comprising:
a slave control device;
a zone control device as the first controller;
an upstream power distribution unit and a central control device as the second controller, wherein
the zone control device is communicatively connected to the slave control device,
the upstream power distribution unit includes the power switch, and
the central control device is communicatively connected to both the zone control device and the upstream power distribution unit.

15. The communication system according to claim 9, comprising:
a slave control device;
a zone control device as the first controller;
an upstream power distribution unit and a central control device as the second controller, wherein
the zone control device is communicatively connected to the slave control device,
the upstream power distribution unit includes the at least one of the power switches; and
the central control device is connected to both the zone control device and the upstream power distribution unit.
